(19) United States
(12) Patent Application Publication
(10) Pub. No.: US 2024/0267765 A1
(43) Pub. Date: Aug. 8, 2024

(54) TECHNIQUES FOR INTER-DEVICE CROSS-LINK INTERFERENCE MEASUREMENTS

(71) Applicant: QUALCOMM Incorporated, San Diego, CA (US)

(72) Inventors: Qian Zhang, Basking Ridge, NJ (US); Lei Xiao, San Jose, CA (US); Muhammad Sayed Khairy Abdelghaffar, San Jose, CA (US); Yan Zhou, San Diego, CA (US)

(21) Appl. No.: 18/165,854

(22) Filed: Feb. 7, 2023

(51) Int. Cl. H04W 24/08

(52) U.S. Cl. CPC H04W 24/08; H04W 92/18

(57) ABSTRACT

Methods, systems, and devices for wireless communication are described. A first user equipment (UE) may receive a control message that triggers reception of CLI reference signals for CLI measurements. The first UE may adjust a reception timing of the first UE for the CLI measurements. The first UE may adjust the reception timing during a time interval that occurs after the control message is received and in accordance with a rule to align the reception timing of the first UE with a transmission timing of a second UE. The transmission timing of the second UE may be associated with transmission of the CLI reference signals from the second UE. The first UE may perform the CLI measurements using the adjusted reception timing in accordance with the rule. The first UE may transmit a report to the network entity that indicates one or more CLI metrics corresponding to the CLI measurements.

### FIELD OF TECHNOLOGY

The following relates to wireless communication, including techniques for inter-device cross-link interference (CLI) measurements.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In scenarios in which communication devices are relatively near each other, communicate at approximately the same time, and/or use a same or similar set of subbands, a communication device may experience cross-link interference (CLI) from one or more other communication devices.

### SUMMARY

The described techniques relate to improved methods, systems, devices, and apparatuses that support techniques for inter-device cross-link interference (CLI) measurements. For example, the described techniques provide a framework for aligning a transmission timing used for transmission of CLI reference signals with a reception timing used for performing CLI measurements using the CLI reference signals. In some examples, a first user equipment (UE) may receive a control message from a network entity that triggers reception of one or more UE-to-UE CLI reference signals for one or more UE-to-UE CLI measurements. In such an example, the first UE may adjust a reception timing of the first UE for receiving the UE-to-UE reference signals and performing the one or more UE-to-UE CLI measurements. In some examples, the first UE may adjust the reception timing during a time interval that occurs after the control message is received. Additionally, in some examples, the first UE may adjust the reception timing in accordance with a rule to align the reception timing of the first UE with a transmission timing of a second UE. The transmission timing of the second UE may be associated with transmission of the one or more UE-to-UE CLI reference signals from the second UE. The first UE may perform the one or more UE-to-UE CLI measurements using the adjusted reception timing in accordance with the rule. In some examples, the first UE may transmit a report to the network entity that indicates one or more CLI metrics corresponding to the one or more UE-to-UE CLI measurements.

A method for wireless communication at a first UE is described. The method may include receiving, from a network entity, a control message that triggers reception of one or more UE-to-UE CLI reference signals for one or more UE-to-UE CLI measurements, adjusting a reception timing of the first UE for the one or more UE-to-UE CLI measurements, where the reception timing is adjusted during a time interval that occurs after the control message is received and in accordance with a rule to align the reception timing of the first UE with a transmission timing of a second UE that is associated with transmission of the one or more UE-to-UE CLI reference signals from the second UE, performing the one or more UE-to-UE CLI measurements using the adjusted reception timing in accordance with the rule, and transmitting, to the network entity, a report that indicates one or more CLI metrics corresponding to the one or more UE-to-UE CLI measurements.

An apparatus for wireless communication at a first UE is described. The apparatus may include a processor, memory coupled with the processor, and instructions stored in the memory. The instructions may be executable by the processor to cause the apparatus to receive, from a network entity, a control message that triggers reception of one or more UE-to-UE CLI reference signals for one or more UE-to-UE CLI measurements, adjust a reception timing of the first UE for the one or more UE-to-UE CLI measurements, where the reception timing is adjusted during a time interval that occurs after the control message is received and in accordance with a rule to align the reception timing of the first UE with a transmission timing of a second UE that is associated with transmission of the one or more UE-to-UE CLI reference signals from the second UE, perform the one or more UE-to-UE CLI measurements using the adjusted reception timing in accordance with the rule, and transmit, to the network entity, a report that indicates one or more CLI metrics corresponding to the one or more UE-to-UE CLI measurements.

Another apparatus for wireless communication at a first UE is described. The apparatus may include means for receiving, from a network entity, a control message that triggers reception of one or more UE-to-UE CLI reference signals for one or more UE-to-UE CLI measurements, means for adjusting a reception timing of the first UE for the one or more UE-to-UE CLI measurements, where the reception timing is adjusted during a time interval that occurs after the control message is received and in accordance with a rule to align the reception timing of the first UE with a transmission timing of a second UE that is associated with transmission of the one or more UE-to-UE CLI reference signals from the second UE, means for performing the one or more UE-to-UE CLI measurements using the adjusted reception timing in accordance with the rule, and means for transmitting, to the network entity, a report that indicates one or more CLI metrics corresponding to the one or more UE-to-UE CLI measurements.

A non-transitory computer-readable medium storing code for wireless communication at a first UE is described. The code may include instructions executable by a processor to receive, from a network entity, a control message that triggers reception of one or more UE-to-UE CLI reference signals for one or more UE-to-UE CLI measurements, adjust a reception timing of the first UE for the one or more UE-to-UE CLI measurements, where the reception timing is adjusted during a time interval that occurs after the control message is received and in accordance with a rule to align the reception timing of the first UE with a transmission timing of a second UE that is associated with transmission of the one or more UE-to-UE CLI reference signals from the second UE, perform the one or more UE-to-UE CLI measurements using the adjusted reception timing in accordance with the rule, and transmit, to the network entity, a report that indicates one or more CLI metrics corresponding to the one or more UE-to-UE CLI measurements.

In some examples of the method, apparatuses, and non-transitory computer-readable medium described herein, receiving the control message may include operations, features, means, or instructions for receiving the control message via a first time-domain resource, where the control message indicates a second time-domain resource for the one or more UE-to-UE CLI measurements that occurs after the time interval in accordance with the rule.

In some examples of the method, apparatuses, and non-transitory computer-readable medium described herein, the rule indicates that the first time-domain resource occurs in a first slot and the second time-domain resource occurs in a second slot different from the first slot.

In some examples of the method, apparatuses, and non-transitory computer-readable medium described herein, the rule indicates that a difference between the first time-domain resource and the second time-domain resource satisfies a threshold that may be based on the time interval.

Some examples of the method, apparatuses, and non-transitory computer-readable medium described herein may further include operations, features, means, or instructions for receiving, from the network entity, an indication of the time interval in accordance with the rule.

In some examples of the method, apparatuses, and non-transitory computer-readable medium described herein, the control message includes the indication of the time interval.

Some examples of the method, apparatuses, and non-transitory computer-readable medium described herein may further include operations, features, means, or instructions for transmitting, to the network entity, an acknowledgment message responsive to the control message, where the time interval may be based on the acknowledgment message.

In some examples of the method, apparatuses, and non-transitory computer-readable medium described herein, the time interval may be based on one or more capabilities of the first UE.

In some examples of the method, apparatuses, and non-transitory computer-readable medium described herein, adjusting the reception timing of the first UE may include operations, features, means, or instructions for adjusting the reception timing by applying a timing offset that may be based on the rule.

In some examples of the method, apparatuses, and non-transitory computer-readable medium described herein, the timing offset includes a timing advance offset of the first UE for uplink transmissions.

In some examples of the method, apparatuses, and non-transitory computer-readable medium described herein, the timing offset includes a timing advance offset of a second UE that may be associated with the transmission timing.

Some examples of the method, apparatuses, and non-transitory computer-readable medium described herein may further include operations, features, means, or instructions for receiving, from the network entity, an indication of the timing offset in accordance with the rule.

Some examples of the method, apparatuses, and non-transitory computer-readable medium described herein may further include operations, features, means, or instructions for adjusting a second transmission timing of the first UE for uplink transmissions or a second reception timing of the first UE for downlink receptions in accordance with a second time interval that occurs before or after the one or more UE-to-UE CLI measurements in accordance with the rule.

In some examples of the method, apparatuses, and non-transitory computer-readable medium described herein, the one or more UE-to-UE CLI measurements may be associated with a half-duplex operation mode at the first UE.

In some examples of the method, apparatuses, and non-transitory computer-readable medium described herein, the one or more UE-to-UE CLI measurements may be associated with a full-duplex operation mode at the network entity.

In some examples of the method, apparatuses, and non-transitory computer-readable medium described herein, the one or more UE-to-UE CLI measurements may be associated with a SBFD operation mode at the network entity.

In some examples of the method, apparatuses, and non-transitory computer-readable medium described herein, the one or more UE-to-UE CLI measurements may be associated with a half-duplex operation mode at the network entity and with a misaligned slot format.

Some examples of the method, apparatuses, and non-transitory computer-readable medium described herein may further include operations, features, means, or instructions for transmitting, to the network entity, an indication of a recommended timing offset for adjustment of the transmission timing of the second UE.

A method for wireless communication at a first UE is described. The method may include receiving, from a network entity, a control message that triggers a transmission of one or more UE-to-UE CLI reference signals, adjusting a transmission timing of the first UE for the transmission of the one or more UE-to-UE CLI reference signals based on a rule to align the transmission timing with a reception timing of a second UE that is associated with one or more UE-to-UE CLI measurements at the second UE, and transmitting, to the network entity, the one or more UE-to-UE CLI reference signals using the adjusted transmission timing in accordance with the rule.

An apparatus for wireless communication at a first UE is described. The apparatus may include a processor, memory coupled with the processor, and instructions stored in the memory. The instructions may be executable by the processor to cause the apparatus to receive, from a network entity, a control message that triggers a transmission of one or more UE-to-UE CLI reference signals, adjust a transmission timing of the first UE for the transmission of the one or more UE-to-UE CLI reference signals based on a rule to align the transmission timing with a reception timing of a second UE that is associated with one or more UE-to-UE CLI measurements at the second UE, and transmit, to the network entity, the one or more UE-to-UE CLI reference signals using the adjusted transmission timing in accordance with the rule.

Another apparatus for wireless communication at a first UE is described. The apparatus may include means for receiving, from a network entity, a control message that triggers a transmission of one or more UE-to-UE CLI reference signals, means for adjusting a transmission timing of the first UE for the transmission of the one or more UE-to-UE CLI reference signals based on a rule to align the transmission timing with a reception timing of a second UE that is associated with one or more UE-to-UE CLI measurements at the second UE, and means for transmitting, to the network entity, the one or more UE-to-UE CLI reference signals using the adjusted transmission timing in accordance with the rule.

A non-transitory computer-readable medium storing code for wireless communication at a first UE is described. The code may include instructions executable by a processor to receive, from a network entity, a control message that triggers a transmission of one or more UE-to-UE CLI reference signals, adjust a transmission timing of the first UE for the transmission of the one or more UE-to-UE CLI reference signals based on a rule to align the transmission timing with a reception timing of a second UE that is associated with one or more UE-to-UE CLI measurements at the second UE, and transmit, to the network entity, the one or more UE-to-UE CLI reference signals using the adjusted transmission timing in accordance with the rule.

Some examples of the method, apparatuses, and non-transitory computer-readable medium described herein may further include operations, features, means, or instructions for receiving, from the network entity, an indication of a timing advance offset associated with the transmission of the one or more UE-to-UE CLI reference signals, where the timing advance offset may be based on the rule, and where the transmission timing may be adjusted in accordance with the timing advance offset.

In some examples of the method, apparatuses, and non-transitory computer-readable medium described herein, adjusting the transmission timing of the first UE may include operations, features, means, or instructions for adjusting the transmission timing of the first UE in accordance with the rule to align the transmission timing of the first UE with a second reception timing of the first UE for downlink receptions.

Some examples of the method, apparatuses, and non-transitory computer-readable medium described herein may further include operations, features, means, or instructions for adjusting a second reception timing of the first UE for downlink receptions or a second transmission timing of the first UE for uplink transmissions in accordance with a second time interval that occurs before or after the transmission of the one or more UE-to-UE CLI reference signals and based on the rule.

In some examples of the method, apparatuses, and non-transitory computer-readable medium described herein, the transmission of the one or more UE-to-UE CLI reference signals may be in accordance with a half-duplex operation mode at the first UE.

In some examples of the method, apparatuses, and non-transitory computer-readable medium described herein, the one or more UE-to-UE CLI measurements may be associated with a full-duplex operation mode at the network entity.

In some examples of the method, apparatuses, and non-transitory computer-readable medium described herein, the one or more UE-to-UE CLI measurements may be associated with a SBFD operation mode at the network entity.

In some examples of the method, apparatuses, and non-transitory computer-readable medium described herein, the one or more UE-to-UE CLI measurements may be associated with a half-duplex operation mode at the network entity.

A method for wireless communication at a network entity is described. The method may include outputting a first indication that triggers reception of one or more UE-to-UE CLI reference signals for one or more UE-to-UE CLI measurements at a UE, outputting a second indication of a time interval that occurs after the first indication is output from the network entity and that is based on a rule to align a reception timing of the first UE with a transmission timing of a second UE that is associated with transmission of the one or more UE-to-UE CLI reference signals from the second UE, and obtaining a report in response to the first indication, where the report indicates one or more CLI metrics corresponding to the one or more UE-to-UE CLI measurements.

An apparatus for wireless communication at a network entity is described. The apparatus may include a processor, memory coupled with the processor, and instructions stored in the memory. The instructions may be executable by the processor to cause the apparatus to output a first indication that triggers reception of one or more UE-to-UE CLI reference signals for one or more UE-to-UE CLI measurements at a UE, output a second indication of a time interval that occurs after the first indication is output from the network entity and that is based on a rule to align a reception timing of the first UE with a transmission timing of a second UE that is associated with transmission of the one or more UE-to-UE CLI reference signals from the second UE, and obtain a report in response to the first indication, where the report indicates one or more CLI metrics corresponding to the one or more UE-to-UE CLI measurements.

Another apparatus for wireless communication at a network entity is described. The apparatus may include means for outputting a first indication that triggers reception of one or more UE-to-UE CLI reference signals for one or more UE-to-UE CLI measurements at a UE, means for outputting a second indication of a time interval that occurs after the first indication is output from the network entity and that is based on a rule to align a reception timing of the first UE with a transmission timing of a second UE that is associated with transmission of the one or more UE-to-UE CLI reference signals from the second UE, and means for obtaining a report in response to the first indication, where the report indicates one or more CLI metrics corresponding to the one or more UE-to-UE CLI measurements.

A non-transitory computer-readable medium storing code for wireless communication at a network entity is described. The code may include instructions executable by a processor to output a first indication that triggers reception of one or more UE-to-UE CLI reference signals for one or more UE-to-UE CLI measurements at a UE, output a second indication of a time interval that occurs after the first indication is output from the network entity and that is based on a rule to align a reception timing of the first UE with a transmission timing of a second UE that is associated with transmission of the one or more UE-to-UE CLI reference signals from the second UE, and obtain a report in response to the first indication, where the report indicates one or more CLI metrics corresponding to the one or more UE-to-UE CLI measurements.

In some examples of the method, apparatuses, and non-transitory computer-readable medium described herein, outputting the first indication may include operations, features, means, or instructions for outputting a control message that includes the first indication via a first time-domain resource, where the control message indicates a second time-domain resource for the one or more UE-to-UE CLI measurements that occurs after the time interval in accordance with the rule.

In some examples of the method, apparatuses, and non-transitory computer-readable medium described herein, the rule indicates that the first time-domain resource occurs in a first slot and the second time-domain resource occurs in a second slot different from the first slot.

In some examples of the method, apparatuses, and non-transitory computer-readable medium described herein, the rule indicates that a difference between the first time-domain resource and the second time-domain resource satisfies a threshold that may be based on the time interval.

Some examples of the method, apparatuses, and non-transitory computer-readable medium described herein may further include operations, features, means, or instructions for outputting a control message that includes the first indication and the second indication in accordance with the rule.

Some examples of the method, apparatuses, and non-transitory computer-readable medium described herein may further include operations, features, means, or instructions for obtaining an acknowledgment message responsive to the first indication, where the time interval occurs after the acknowledgment message may be obtained.

In some examples of the method, apparatuses, and non-transitory computer-readable medium described herein, the time interval may be based on one or more capabilities associated with the first UE.

In some examples of the method, apparatuses, and non-transitory computer-readable medium described herein, the reception timing may be adjusted in accordance with a timing offset that may be based on the rule.

In some examples of the method, apparatuses, and non-transitory computer-readable medium described herein, the timing offset includes a timing advance offset of the first UE for uplink transmissions.

In some examples of the method, apparatuses, and non-transitory computer-readable medium described herein, the timing offset includes a timing advance offset of the second UE that may be associated with the transmission timing.

Some examples of the method, apparatuses, and non-transitory computer-readable medium described herein may further include operations, features, means, or instructions for outputting an indication of the timing offset for the one or more UE-to-UE CLI measurements in accordance with the rule.

In some examples of the method, apparatuses, and non-transitory computer-readable medium described herein, a second transmission timing of the first UE for uplink transmissions or a second reception timing of the first UE for downlink receptions may be adjusted in accordance with a second time interval that occurs before or after the one or more UE-to-UE CLI measurements in accordance with the rule.

In some examples of the method, apparatuses, and non-transitory computer-readable medium described herein, the one or more UE-to-UE CLI measurements may be associated with a half-duplex operation mode at the first UE.

In some examples of the method, apparatuses, and non-transitory computer-readable medium described herein, the one or more UE-to-UE CLI measurements may be associated with a full-duplex operation mode at the network entity.

In some examples of the method, apparatuses, and non-transitory computer-readable medium described herein, the one or more UE-to-UE CLI measurements may be associated with a SBFD operation mode at the network entity.

In some examples of the method, apparatuses, and non-transitory computer-readable medium described herein, the one or more UE-to-UE CLI measurements may be associated with a half-duplex operation mode at the network entity.

Some examples of the method, apparatuses, and non-transitory computer-readable medium described herein may further include operations, features, means, or instructions for obtaining an indication of a recommended timing offset for the transmission timing.

A method for wireless communication at a network entity is described. The method may include outputting a first indication that triggers a transmission of one or more UE-to-UE CLI reference signals at a first UE, outputting a second indication of a timing offset associated with a transmission timing of the first UE for the transmission of the one or more UE-to-UE CLI reference signals, the timing offset is based on a rule that aligns the transmission timing of the first UE with a reception timing of a second UE that is associated with one or more UE-to-UE CLI measurements at the second UE, and obtaining the one or more UE-to-UE CLI reference signals in accordance with the rule and an adjustment to the transmission timing of the first UE that is based on the timing offset.

An apparatus for wireless communication at a network entity is described. The apparatus may include a processor, memory coupled with the processor, and instructions stored in the memory. The instructions may be executable by the processor to cause the apparatus to output a first indication that triggers a transmission of one or more UE-to-UE CLI reference signals at a first UE, output a second indication of a timing offset associated with a transmission timing of the first UE for the transmission of the one or more UE-to-UE CLI reference signals, the timing offset is based on a rule that aligns the transmission timing of the first UE with a reception timing of a second UE that is associated with one or more UE-to-UE CLI measurements at the second UE, and obtain the one or more UE-to-UE CLI reference signals in accordance with the rule and an adjustment to the transmission timing of the first UE that is based on the timing offset.

Another apparatus for wireless communication at a network entity is described. The apparatus may include means for outputting a first indication that triggers a transmission of one or more UE-to-UE CLI reference signals at a first UE, means for outputting a second indication of a timing offset associated with a transmission timing of the first UE for the transmission of the one or more UE-to-UE CLI reference signals, the timing offset is based on a rule that aligns the transmission timing of the first UE with a reception timing of a second UE that is associated with one or more UE-to-UE CLI measurements at the second UE, and means for obtaining the one or more UE-to-UE CLI reference signals in accordance with the rule and an adjustment to the transmission timing of the first UE that is based on the timing offset.

A non-transitory computer-readable medium storing code for wireless communication at a network entity is described. The code may include instructions executable by a processor to output a first indication that triggers a transmission of one or more UE-to-UE CLI reference signals at a first UE, output a second indication of a timing offset associated with a transmission timing of the first UE for the transmission of the one or more UE-to-UE CLI reference signals, the timing offset is based on a rule that aligns the transmission timing of the first UE with a reception timing of a second UE that is associated with one or more UE-to-UE CLI measurements at the second UE, and obtain the one or more UE-to-UE CLI reference signals in accordance with the rule and an adjustment to the transmission timing of the first UE that is based on the timing offset.

Some examples of the method, apparatuses, and non-transitory computer-readable medium described herein may further include operations, features, means, or instructions for obtaining an indication of a recommended timing advance offset from the second UE, where the timing offset associated with the transmission timing of the first UE may be based on the recommended timing advance offset.

In some examples of the method, apparatuses, and non-transitory computer-readable medium described herein, the transmission timing of the first UE may be adjusted in accordance with the rule to align the transmission timing of the first UE with a second reception timing of the first UE for downlink receptions.

In some examples of the method, apparatuses, and non-transitory computer-readable medium described herein, a second reception timing of the first UE for downlink receptions or a second transmission timing of the first UE for uplink transmissions may be adjusted in accordance with a second time interval that occurs before or after the transmission of the one or more UE-to-UE CLI reference signals and based on the rule.

In some examples of the method, apparatuses, and non-transitory computer-readable medium described herein, the transmission of the one or more UE-to-UE CLI reference signals may be in accordance with a half-duplex operation mode at the first UE.

In some examples of the method, apparatuses, and non-transitory computer-readable medium described herein, the one or more UE-to-UE CLI measurements may be associated with a full-duplex operation mode at the network entity.

In some examples of the method, apparatuses, and non-transitory computer-readable medium described herein, the one or more UE-to-UE CLI measurements may be associated with a SBFD operation mode at the network entity.

In some examples of the method, apparatuses, and non-transitory computer-readable medium described herein, the one or more UE-to-UE CLI measurements may be associated with a half-duplex operation mode at the network entity.

### BRIEF DESCRIPTION OF THE DRAWINGS

FIGS. 1 and 2 each illustrate an example of a wireless communications system that supports techniques for inter-device cross-link interference (CLI) measurements in accordance with one or more aspects of the present disclosure.

FIG. 3 illustrates an example of an interference measurement diagram that supports techniques for inter-device CLI measurements in accordance with one or more aspects of the present disclosure.

FIG. 4A illustrates an example of a wireless communications system that supports techniques for inter-device CLI measurements in accordance with one or more aspects of the present disclosure.

FIG. 4B illustrates an example of a timing diagram that supports techniques for inter-device CLI measurements in accordance with one or more aspects of the present disclosure.

FIGS. 5 and 6 each illustrate an example of a process flow that supports techniques for inter-device CLI measurements in accordance with one or more aspects of the present disclosure.

FIGS. 7 and 8 illustrate block diagrams of devices that support techniques for inter-device CLI measurements in accordance with one or more aspects of the present disclosure.

FIG. 9 illustrates a block diagram of a communications manager that supports techniques for inter-device CLI measurements in accordance with one or more aspects of the present disclosure.

FIG. 10 illustrates a diagram of a system including a device that supports techniques for inter-device CLI measurements in accordance with one or more aspects of the present disclosure.

FIGS. 11 and 12 illustrate block diagrams of devices that support techniques for inter-device CLI measurements in accordance with one or more aspects of the present disclosure.

FIG. 13 illustrates a block diagram of a communications manager that supports techniques for inter-device CLI measurements in accordance with one or more aspects of the present disclosure.

FIG. 14 illustrates a diagram of a system including a device that supports techniques for inter-device CLI measurements in accordance with one or more aspects of the present disclosure.

FIGS. 15 through 18 illustrate flowcharts showing methods that support techniques for inter-device CLI measurements in accordance with one or more aspects of the present disclosure.

### DETAILED DESCRIPTION

Some wireless communications systems may include a communication device, such as a user equipment (UE) or a network entity, that support wireless communications in accordance with a half-duplex mode or a full-duplex mode, or a combination thereof. For example, in a half-duplex mode, the communication device may either transmit communications or receive communications during a time interval, such as a transmission time interval (TTI), that may span one or more time resources (e.g., symbols, mini-slots, slot). In a full-duplex mode, the communication device may transmit and receive communications simultaneously or concurrently. For example, communications received by the communication device may overlap in the time domain with communications transmitted by the communication device. In other words, symbols occupied by or allocated for received signals may overlap with symbols occupied by or allocated for transmitted signals. In some examples, neighboring communication devices (e.g., network entities) may perform full-duplex communications or half-duplex time division duplexing (TDD) concurrently, such that downlink communications received by a first communication device may overlap in time, at least partially, with uplink communications transmitted from a second communication device (e.g., a neighboring communication device). In such an example, the uplink communications transmitted from the second communication device may interfere with the downlink communications received at the first communication device. Such interference may be referred to as cross-link interference (CLI). In some examples, CLI may degrade wireless communications between the first communication device and the network.

To mitigate or reduce effects of CLI, the network may configure the first communication device to measure and report CLI. For example, the network may configure the first communication device to perform a CLI measurement on a reference signal transmitted from the second communication device. In such an example, the first communication device may use a reception timing to determine when the first communication device may receive the reference signal and, therefore, when to perform the CLI measurement. Additionally, the second communication device may use a transmission timing to determine when to transmit the reference signal for the CLI measurement at the first communication device. The reception timing of the first communication device may be based on a first propagation delay experienced at the first communication device and the transmission timing of the second communication device may be based on a second propagation delay experienced at the second communication device. In some examples, however, the first propagation delay may be different from the second propagation delay, which may cause the reception timing of first communication device and the transmission timing of the second communication device to be misaligned. Misalignment between the reception timing of the first communication device and the transmission timing of the second communication device may lead to inaccuracies in CLI measurements performed at the first communication device.

Various aspects of the present disclosure generally relate to techniques for inter-device CLI measurements and, more specifically, to a framework for aligning a transmission timing used for transmission of reference signals for CLI measurements (e.g., CLI reference signals) with a reception timing used for performing CLI measurements. In some examples, the first communication device may adjust a reception timing used at the first communication device for performing CLI measurements using CLI reference signals and the second communication device may refrain from adjusting a transmission timing used at the second communication device for transmission of CLI reference signals. For example, the first communication device may be configured with a rule for adjusting the reception timing to align with the transmission timing of the second communication device.

The first communication device may receive a first control message from the network that may trigger the first communication device to perform a CLI measurement using a CLI reference signal transmitted from the second communication device. In some examples, the first communication device may adjust the reception timing during a time interval that occurs after the first control message is received. For example, the first communication device may receive the first control message in a slot and the rule may indicate that the first communication device may not expect the first control message to schedule reception of the CLI reference signal (e.g., for the CLI measurement) in the same slot. In some other examples, the rule may indicate the first communication device may not expect the first control message to schedule reception of the CLI reference signal within a time interval that fails to satisfy a threshold time interval. That is, the reception of the CLI reference signal may not occur until the time interval has expired.

The rule may enable the first communication device to adjust the reception timing of the first communication device for the CLI measurement during the time interval. The first communication device may adjust the reception timing in accordance with the rule. The rule may configure or enable the first communication device to adjust the reception timing by applying a timing offset that may be based on the rule. For example, the timing offset may include a timing advance offset configured at the first communication device for downlink receptions (or uplink transmissions). Alternatively, the timing offset may include a timing advance offset configured at the second communication device for uplink transmissions (or downlink receptions). In some examples, the network may indicate the timing offset to the first communication device. The first communication device may perform the CLI measurement using the reception timing adjusted in accordance with the rule. Additionally, in some examples, the first communication device may transmit a report to the network that indicates one or more CLI metrics corresponding to the CLI measurement.

In some other examples, the second communication device may adjust a transmission timing of the second communication device for transmission of the CLI reference signal, and the first communication device may refrain from adjusting a reception timing of the second communication device for the CLI measurement. For example, the second communication device may be configured with a rule for adjusting the transmission timing to align the reception timing of the first communication device. The second communication device may receive a second control message from the network that may trigger the second communication device to transmit a CLI reference signal. The second communication device may adjust the transmission timing for transmission of the CLI reference signal based on the rule. In some examples, the rule may configure or enable the second communication device to adjust the transmission timing based on a timing advance offset configured at the second communication device for CLI measurements. In some other examples, the rule may configure or enable the second communication device to autonomously adjust the transmission timing for transmission of CLI reference signals. The second communication device may transmit the CLI reference signal in accordance with the transmission timing adjusted in accordance with the rule.

Particular aspects of the subject matter described herein may be implemented to realize one or more of the following potential advantages. The techniques employed by the described communication devices may provide benefits and enhancements to the operation of the communication devices, including enabling alignment of a transmission timing used for transmission of CLI reference signals with a reception timing used for CLI measurements of the CLI reference signals. In some examples, operations performed at one or more of the communication devices to align the transmission timing with the reception timing may provide one or more enhancements for CLI measurement and reporting. Further, aspects of techniques for inter-device CLI measurements, as described herein, may lead to increased communication reliability and reduced latency within a wireless communications system, among other possible benefits. Aspects of the disclosure are initially described in the context of wireless communications systems.

Aspects of the precent disclosure are also described in the context of an interference measurement diagram, a timing diagram, and process flows. Aspects of the disclosure are further illustrated by and described with reference to apparatus diagrams, system diagrams, and flowcharts that relate to techniques for inter-device (e.g., UE-to-UE) CLI measurements.

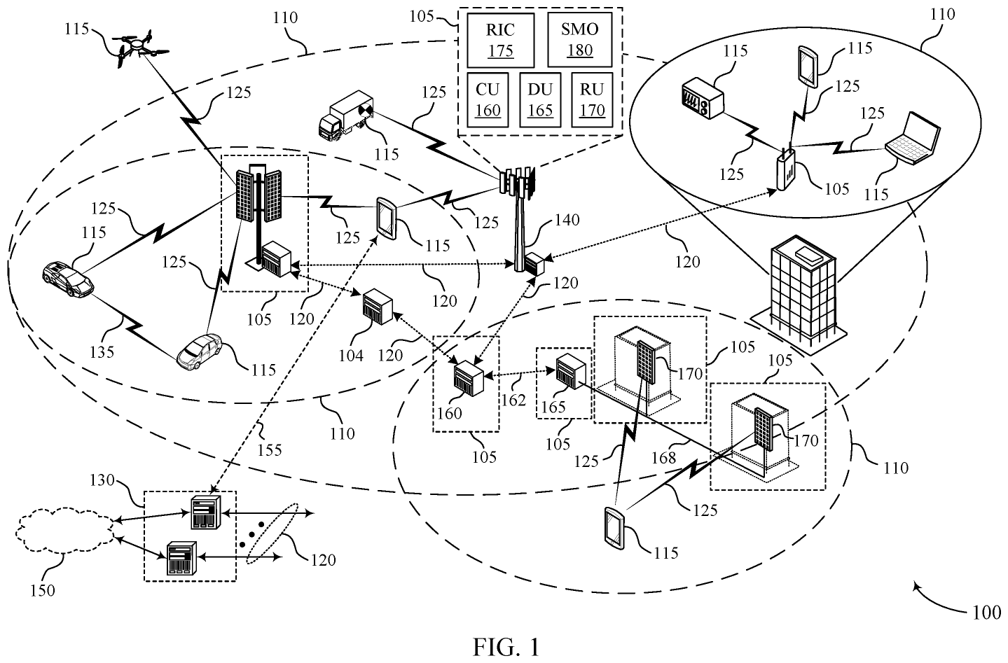

FIG. 1 illustrates an example of a wireless communications system 100 that supports techniques for inter-device CLI measurements in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for inter-device CLI measurements as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and TDD component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Various devices within the wireless communications system 100 may support one or more levels of duplex operation, which may depend on or be associated with a deployment scenario, a duplex mode (such as TDD only, FDD only, or both TDD and FDD), or an interference management procedure. In some aspects, a wireless device (e.g., a UE 115, a network entity 105, or an IAB node 104) within the wireless communications system 100 may support half-duplex or full-duplex operation. For example, a network entity 105 may support various types of MIMO communication, including downlink multi-user MIMO (MU-MIMO) according to which the network entity 105 may transmit downlink signaling to two different UEs 115 simultaneously, uplink MU-MIMO according to which the network entity 105 may receive uplink signaling from two different UEs 115 simultaneously, or downlink and uplink MU-MIMO (which may be referred to herein as full-duplex operation) according to which the network entity 105 may transmit downlink signaling to a first UE 115 while simultaneously receiving uplink signaling from a second UE 115. A network entity 105 may further support enhanced MIMO (eMIMO) or further enhanced MIMO (FeMIMO), which may be associated with an FeMIMO beam management session. In accordance with full-duplex operation, a wireless device may be capable of transmitting and receiving simultaneously. In other words, the wireless device may support simultaneous uplink and downlink transmissions (such as an uplink transmission and a downlink transmission that at least partially overlap in time). In some examples, simultaneous uplink and downlink transmissions at a wireless device may lead to one or more types of interference at the wireless device or at a neighboring wireless device, or both. For example, the simultaneously uplink and downlink transmissions at a wireless device may lead to self-interference, CLI, interference caused by clutter (e.g., by objects such as buildings reflecting transmitted signaling), or any combination thereof.

In some aspects, a network entity 105 and a UE 115 may support various evaluation techniques and performance evaluation metrics associated with different deployment scenarios for full-duplex operation (such as for NR duplexing). Further, a network entity 105 and a UE 115 may support one or more techniques to support co-existence with other systems in any co-channels or adjacent channels for subband non-overlapping full-duplex operation or for dynamic or flexible TDD, or for both. For example, a network entity 105 and a UE 115 may support techniques associated with duplex operation evolution for NR TDD across various spectrums, including in an unpaired spectrum. In such examples, the network entity 105 may support full-duplex operation, a UE 115 may support half-duplex operation, and the network entity 105 and the UE 115 may configure or expect some relatively reduced constraints (e.g., reduced or no restrictions) on which frequency ranges may be available for use.

Such techniques may include various full-duplex types or schemes and corresponding metrics to evaluate a performance of such full-duplex types or schemes, inter-network entity (e.g., inter-gNB) and inter-UE CLI mitigation techniques, intra-subband CLI and inter-subband CLI mitigation techniques (such as in the implementation of subband non-overlapping full-duplex), or a metric-based evaluation procedure for an impact of full-duplex operation on half-duplex operation (assuming co-existence in co-channel and adjacent channels). Additionally, or alternatively, such techniques may include a metric-based evaluation procedure for an impact on RF constraints considering adjacent channel co-existence or for an impact on RF constraints considering self-interference, inter-subband CLI and inter-operator CLI at network entities 105, and inter-subband CLI and inter-operator CLI at UEs 115. Further, such techniques may include antenna or RF and algorithm design for interference mitigation, including antenna isolation, transmission interference management suppression in a receive-side part, filtering, and digital interference suppression. Further, such techniques may comply with one or more regulatory or network specifications associated with full-duplex operation in TDD unpaired spectrums.

Further, some systems may support one or more techniques associated with dynamic or flexible TDD or subband full-duplex (SBFD), or both, for inter-UE CLI handling (e.g., UE-to-UE CLI handling) or inter-gNB CLI handling (gNB-to-gNB CLI handling), or both. Such techniques may include mechanisms related to UE-to-UE CLI measurement and reporting, coordinated scheduling, spatial domain designs, receiver designs, UE and network entity transmission and reception timing, power control-based designs, or sensing-based mechanisms, among other example techniques associated with UE-to-UE CLI handling or gNB-to-gNB CLI handling. In some aspects, such techniques may be associated with an identification of whether a scheme or design include over-the-air (OTA) or backhaul information exchanges.

Various devices within the wireless communications system 100 may support inter-device CLI measurements. For example, one or more UEs 115 and network entities 105 may support techniques for measurement of CLI experienced at a UE 115 due to uplink transmissions from another UE 115. As described herein, measurement of CLI experienced at a UE 115 due to signaling from another UE 115 may be referred to as UE-to-UE CLI measurements. Additionally, as described herein, reference signals transmitted from a UE 115 for CLI measurements (e.g., UE-to-UE CLI measurements) at another UE 115 may be referred to as UE-to-UE CLI reference signals.

In some examples, techniques for UE-to-UE CLI measurements supported at the UEs 115 and the network entities 105 may provide a framework for aligning a transmission timing used for transmission of CLI reference signals with a reception timing used for performing CLI measurements using the CLI reference signals. For example, a first UE 115 may receive a control message from a network entity 105 that triggers reception of one or more UE-to-UE CLI reference signals for one or more UE-to-UE CLI measurements. In such an example, the first UE 115 may adjust a reception timing of the first UE 115 for the one or more UE-to-UE CLI measurements. In some examples, the first UE 115 may adjust the reception timing during a time interval that occurs after the control message is received. Additionally, in some examples, the first UE 115 may adjust the reception timing in accordance with a rule to align the reception timing of the first UE 115 with a transmission timing of a second UE 115. The transmission timing of the second UE 115 may be associated with transmission of the one or more UE-to-UE CLI reference signals from the second UE 115. The first UE 115 may perform the one or more UE-to-UE CLI measurements using the adjusted reception timing in accordance with the rule. In some examples, the first UE 115 may transmit a report (e.g., a CLI report) to the network entity 105 that indicates one or more CLI metrics corresponding to the one or more UE-to-UE CLI measurements. In some examples, enabling the first UE 115 to align the reception timing of the first UE 115 with the transmission timing used for transmission of the one or more UE-to-UE CLI reference signals may lead to increased communication reliability and reduced latency within the wireless communications system 100, among other possible benefits.

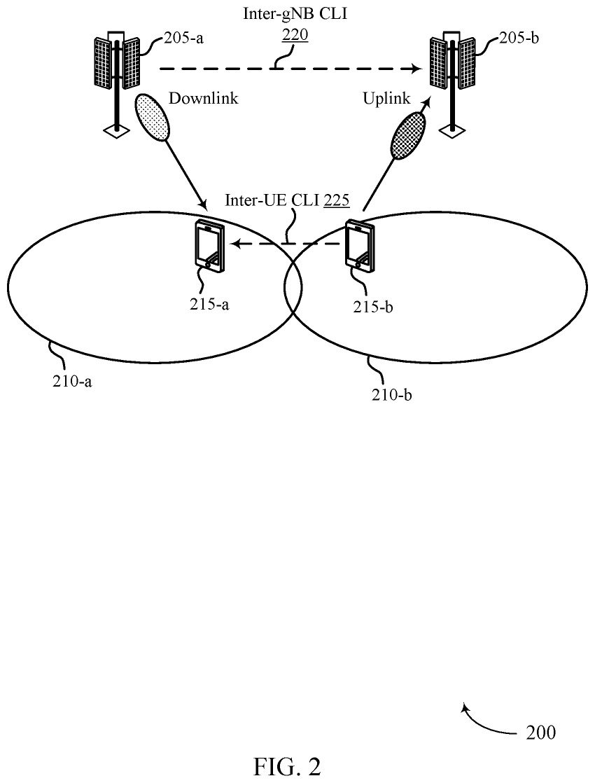

FIG. 2 illustrates an example of wireless communications system 200 that supports techniques for inter-device CLI measurements in accordance with one or more aspects of the present disclosure. The wireless communications system 200 may implement or be implemented to realize or facilitate aspects of the wireless communications system 100. For example, the wireless communications system 200 may include a UE 215-a and a UE 215-b as well as a network entity 205-a and a network entity 205-b. The UE 215-a and the UE 215-b may each be an example of a UE 115 illustrated by and described with reference to FIG. 1. The network entity 205-a and the network entity 205-b may each be an example of a network entity 105 illustrated by and described with reference to FIG. 1. In the example of FIG. 2, the network entity 205-a may be associated with (e.g., serve) a cell 210-a and the network entity 205-b may be associated with (e.g., serve) a cell 210-b.

In some examples of the wireless communications system 200, the network entities 205 may operate in a dynamic TDD mode, which may also be referred to as a flexible TDD mode. Operating in a dynamic TDD mode may enable the network entities 205 to adjust uplink and downlink resources flexibly, for example, based on traffic load (e.g., instantaneous traffic load) within the wireless communications system 200. In some examples, a dynamic TDD mode may include half-duplex operations (e.g., at the network entities 205) with a misaligned slot format. Operating in a dynamic TDD mode may enable increased flexibility for asymmetric services, which may lead to improved spectral efficiency within the wireless communications system 200, among other possible benefits.

In some examples, however, dynamic TDD operations at the network entities 205 may lead to interference between downlink and uplink communications within the wireless communications system 200. For example, dynamic TDD operations at the network entities 205 may enable the network entity 205-a to transmit downlink communications and the network entity 205-b to receive uplink communications concurrently (or overlapping in time), which may lead to inter-gNB CLI 220 at the network entity 205-b. Accordingly, the UE 215-a may receive the downlink communications from the network entity 205-a and the UE 215-b may transmit the uplink communications to the network entity 205-b concurrently (or overlapping in time), which may lead to inter-UE CLI 225 experienced at the UE 215-a. In other words, in some deployment scenarios, such as in deployment scenarios in which the UE 215-a and the UE 215-b are relatively near each other (e.g., despite being served by different cells), uplink signaling transmitted from the UE 215-b (e.g., to the network entity 205-b) may cause inter-UE CLI 225 (e.g., inter-cell inter-UE interference) at the UE 215-a. In some aspects, a UE experiencing CLI (e.g., a UE receiving downlink signals, such as the UE 215-a) may be referred to as a victim UE and a UE causing CLI (e.g., a UE transmitting uplink signals, such as the UE 215-b) may be referred to as an aggressor UE.

In some implementations, one or more of the network entities 205 and one or more of the UEs 215 may support techniques associated with inter-UE CLI mitigation for deployments involving dynamic TDD scenarios, such as may be illustrated in the example of FIG. 2. For example, one or both of the network entities 205 and one or both of the UEs 215 may support UE-to-UE CLI reporting. In some examples, to support CLI reporting, one or both of the UEs 215 may support UE-to-UE CLI measurements. In some examples, to reduce inter-cell CLI and improve decoding of downlink signals at the UE 215-a, the network entity 205-a may configure the UE 215-a to perform one or more CLI measurements (e.g., an RSRP measurement or RSSI measurement) on a reference signal transmitted from the UE 215-b. In such an example, the UE 215-a may use a reception timing to determine when the UE 215-a may receive (e.g., detect) the reference signal and, therefore, when to perform the CLI measurement. Additionally, the UE 215-b may use a transmission timing to determine when to transmit the reference signal for the CLI measurement at the UE 215-a. In some examples, however, the reception timing may be based on a propagation delay experienced at the UE 215-a, which may be different from a propagation delay experienced at the UE 215-b. For example, the propagation delay in signals transmitted between the network entity 205-a and the UE 215-a may be different from a propagation delay in signals transmitted between the network entity 205-b and the UE 215-b. Accordingly, the reception timing of the UE 215-a and the transmission timing of the UE 215-b may be misaligned and cause inaccuracies in CLI measurement performed at the UE 215-a.

In some other examples, however, one or more of the UEs 215 may support one or more schemes for aligning the transmission timing used at the UE 215-b for transmission of CLI reference signals with the reception timing used at the UE 215-a for CLI measurements. For example, to support UE-to-UE CLI measurements in which a transmission from the UE 215-b and a reception at the UE 215-a may have misaligned timing, the UE 215-a may use one or more aspects of techniques for inter-device CLI measurements, as described herein, to adjust the reception timing. As an example, the UE 215-a may modify a reception timing during (e.g., within) a time duration, where the time duration may start after control information scheduling UE-to-UE CLI measurement resources is received. In such examples, the UE 215-a may not expect to have scheduled resources that occur prior to an expiration of the time duration. In such cases, one or more rules or configurations of the time duration may be used to enable the adjustment of the reception timing of the UE 215-a. Additionally, or alternatively, the UE 215-b may use one or more aspects of techniques for inter-device CLI measurements, as described herein, to adjust the transmission timing. Here, the UE 215-b may adjust the transmission timing based on one or more rules or configurations, for example, based on a timing advance that is specific to UE-to-UE CLI reference signal transmissions. In some examples, enabling one or both of the UEs 215 to align a transmission timing used for transmission of CLI reference signals with a reception timing used for CLI measurements of the CLI reference signals may lead to increased accuracy for CLI measurements, among other possible benefits.

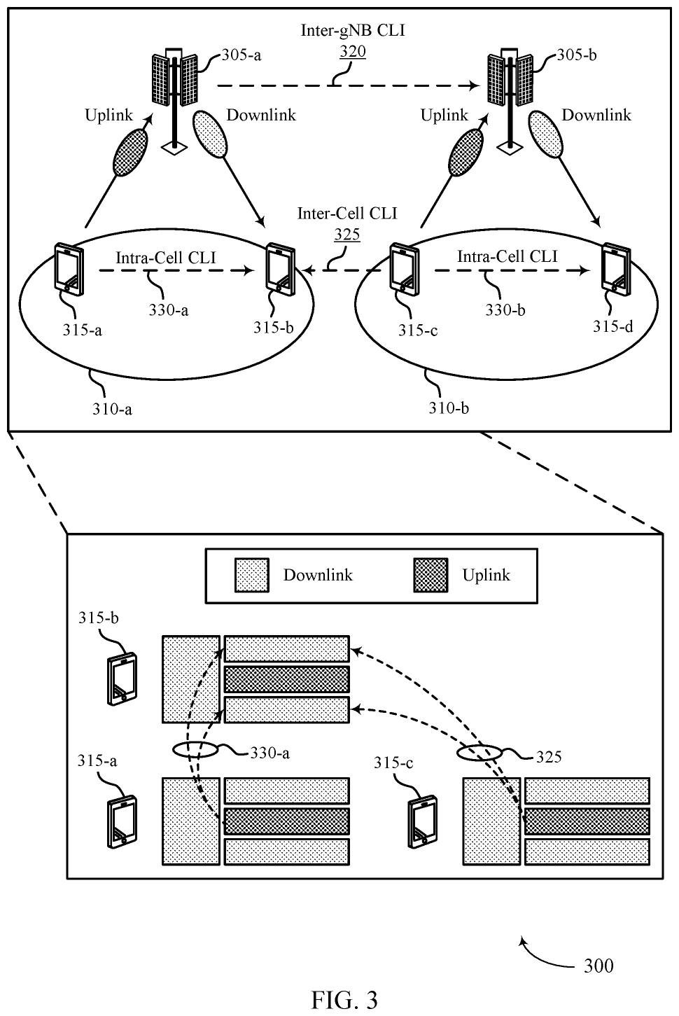

FIG. 3 illustrates an example of an interference measurement diagram 300 that supports techniques for inter-device CLI measurements in accordance with one or more aspects of the present disclosure. The interference measurement diagram 300 may implement or be implemented to realize or facilitate aspects of the wireless communications system 100 and the wireless communications system 200. For example, the interference measurement diagram 300 illustrates interference or potential interference (and corresponding interference measurements) between various wireless communication devices, including a UE 315-a, a UE 315-b, a UE 315-c, and a UE 315-d as well as a network entity 305-a and a network entity 305-b. The UE 315-a, the UE 315-b, the UE 315-c, and the UE 315-d may each be an example of a UE illustrated by and described with reference to FIGS. 1 and 2. The network entity 305-a and the network entity 305-b may each be an example of a network entity illustrated by and described with reference to FIGS. 1 and 2.

In the example of FIG. 3, the network entity 305-a may be associated with a cell 310-a and the network entity 305-b may be associated with a cell 310-b. Within the cell 310-a, the UE 315-a may transmit signaling (e.g., uplink signaling) to the network entity 305-a that may cause intra-cell CLI 330-a at the UE 315-b. Similarly, within the cell 310-b, the UE 315-c may transmit signaling (e.g., uplink signaling) to the network entity 305-b that may cause intra-cell CLI 330-b at the UE 315-d. In some aspects, a UE experiencing CLI (e.g., a UE receiving downlink signals, such as the UE 315-b or the UE 315-d) may be referred to as a victim UE and a UE causing CLI (e.g., a UE transmitting uplink signals, such as the UE 315-a or the UE 315-c) may be referred to as an aggressor UE.

In some deployment scenarios, such as in deployment scenarios in which the UE 315-b and the UE 315-c are relatively near each other (e.g., despite being served by different cells), the signaling transmitted from the UE 315-c (e.g., to the network entity 305-b) may cause inter-cell CLI 325 at the UE 315-b. Inter-cell CLI 325 may be an example of inter-UE CLI illustrated by and described with reference to FIG. 2. For example, the UE 315-b may experience inter-cell CLI 325 from the UE 315-c in scenarios in which the network entity 305-a and the network entity 305-b support dynamic TDD operation. As such, the UE 315-b may experience intra-cell CLI 330-a or inter-cell CLI 325, or both. Further, in some deployment scenarios, the network entity 305-a may transmit signaling (such as downlink signaling to the UE 315-b) that may cause inter-gNB CLI 320. Inter-gNB CLI 320 may be an example of inter-gNB CLI illustrated by and described with reference to FIG. 2.

In examples the network entities 305 (e.g., the network entity 305-a and the network entity 305-b) may support SBFD (e.g., full-duplex communications using resources configured for SBFD). That is, the network entities 305 may support simultaneous transmission of downlink signals and reception of uplink signals on a subband basis. In such an example, the network entities 305 (e.g., full-duplex gNBs) may support simultaneous transmission of downlink signals and reception of uplink signals in a same slot. In some examples, SBFD may provide an increase in an uplink duty cycle which may lead to latency reduction. For example, SBFD operations may enable transmission of an uplink signal in slots allocated for downlink signaling or reception of a downlink signal in a slot allocated for uplink signaling, which may improve (e.g., decrease) communications latency. Additionally, SBFD may lead to enhanced system capacity, resource utilization, and spectrum efficiency, as well as enable flexible and dynamic uplink or downlink resource adaption according to uplink or downlink traffic in a relatively robust manner.

In some examples, such as examples in which the network entities 305 may support SBFD, the intra-cell CLI 330-a, the intra-cell CLI 330-b, the inter-cell CLI 325, and the inter-gNB CLI 320 may include inter-subband CLI. For example, during a slot configured for SBFD at the network entity 305-a, the UE 315-a may transmit an uplink signal to the network entity 305-a using one or more uplink subbands within the slot, while the network entity 305-a may simultaneously use a downlink subband to transmit a downlink signal to the UE 315-b. As such, the uplink signal transmitted from the UE 315-a may cause intra-cell CLI 330-a at the UE 315-b. Additionally, or alternatively, during the slot configured for SBFD at the network entity 305-a and the network entity 305-b, the UE 315-c may transmit an uplink signal to the network entity 305-b using one or more uplink subbands within the slot, while the network entity 305-a may simultaneously use a downlink subband to transmit a downlink signal to the UE 315-b. As such, the uplink signal transmitted from the UE 315-c may cause inter-cell CLI 325 at the UE 315-b.

Additionally, or alternatively, in some examples, the network entity 305-a and the network entity 305-b may support fully or partially overlapped full-duplex. In such examples, the intra-cell CLI 330-a, the intra-cell CLI 330-b, the inter-cell CLI 325, and the inter-gNB CLI 320 may include intra-subband CLI. Accordingly, in some example deployments, such as deployments in which the network entity 305-a and the network entity 305-b may communicate and schedule communication according to a network-side SBFD mode, the UE 315-b may experience inter-subband, intra-cell, inter-UE CLI from the UE 315-a (such as the intra-cell CLI 330-a) and inter-subband, inter-cell, inter-UE CLI from the UE 315-c (such as the inter-cell CLI 325).

In some deployments, the network entity 305-a and the network entity 305-b may each experience some amount of inter-subband or intra-subband, inter-gNB CLI (e.g., the inter-gNB CLI 320). For example, the network entity 305-a may transmit downlink signaling via one or more downlink subbands and such downlink signaling may cause inter-gNB CLI 320 in one or more uplink subbands (in addition to one or more downlink subbands) at the network entity 305-b. Similarly, the network entity 305-b may transmit downlink signaling via one or more downlink subbands and such downlink signaling may cause inter-gNB CLI 320 in one or more uplink subbands (in addition to one or more downlink subbands) at the network entity 305-a.

In some implementations, one or more of the network entities 305 and one or more of the UEs 315 may support techniques associated with inter-UE CLI mitigation for deployments involving subband non-overlapping full-duplex scenarios, for deployments involving partially or fully overlapping full-duplex scenarios, or for deployments involving dynamic TDD scenarios, or any combination thereof. For example, one or more of the network entities 305 and one or more of the UEs 315 may support lower layer (e.g., layer 1 (L1) or layer 2 (L2)) UE-to-UE CLI reporting, which may be periodic, semi-persistent, aperiodic, or event triggered, or any combination thereof. In some examples, to support lower layer CLI reporting, one or more of the UEs 315 may support lower layer UE-to-UE CLI measurements, which may also be periodic, semi-persistent, aperiodic, or event triggered. For example, one or more of the UEs 315 may be configured to perform lower layer UE-to-UE CLI measurements using periodic, semi-persistent, or aperiodic measurement resource.

In some examples, one or more of the UEs 315 may support lower layer UE-to-UE CLI measurement and reporting for UE-to-UE co-channel CLI handling. In some examples, lower layer UE-to-UE CLI measurement and reporting at the UEs 315 may account for (e.g., provide one or more enhancements for) UE processing or reporting delay (or both). For example, the UEs 315 may support one or more mechanisms for lower layer-based CLI measurement and reporting, which may and to provide one or more enhancements for CLI measurement and reporting compared with higher layer (e.g., layer 3 (L3)) CLI or CSI measurement and report. Additionally, or alternatively, some lower layer UE-to-UE CLI measurement and reporting techniques may account for (e.g., provide one or more enhancements for) information exchange delays between network entities (e.g., gNBs). For example, the network entities 305 may perform a CSI comparison in which CQI may reflect CLI information implicitly. In such an example, a UE may experience (e.g., suffers from) increased (e.g., relatively strong) CLI. Accordingly, the UE may report (e.g., feedback) a lower CQI index (e.g., relatively to a previously reported CQI index) to one or both of the network entities 305 (e.g., a gNB). Accordingly, one or both of the network entities may schedule the UE (e.g., a victim UE) with a lower MCS (e.g., relative to a previously-scheduled MCS) or to communicate in a suitable time and frequency resource that may lead to relatively less interference (e.g., CLI) at the UE. In some examples, higher layer (e.g., L3-based) measurements may provide a baseline for potential enhancement to CLI measurement and reporting. Some CSI measurements, such as received signal strength indicator (RSSI) measurements, may be reflected by using a measurement resource which may fail to distinguish UE-to-UE CLI sources. Additionally, some other CLI measurements, such as sounding reference signal (SRS) reference signal received power (RSRP) measurements, may distinguish UE-to-UE CLI as a source and may enable received power measurements.

For example, to reduce CLI (e.g., the intra-cell CLI 330-a, the intra-cell CLI 330-b) and improve decoding of downlink signals at the UE 315-b, the network entity 305-a may configure the UE 315-b to perform one or more CLI measurements (e.g., an RSRP measurement or RSSI measurement) on a reference signal transmitted from a neighboring UE (e.g., the UE 315-a or the UE 315-c). In such an example, the UE 315-b may use a reception timing to determine when the UE 315-b may receive (e.g., detect) the reference signal and, therefore, when to perform the CLI measurement. Additionally, the neighboring UE may use a transmission timing to determine when to transmit the reference signal for the CLI measurement at the UE 315-b. In some examples, however, the reception timing may be based on a propagation delay experienced at the UE 315-b, which may be different from a propagation delay experienced at the neighboring UE. That is, the propagation delay in signals transmitted between the network entity 305-a and the UE 315-b may be different from a propagation delay in signals transmitted between the network entity 305-a and the UE 315-a or a propagation delay transmitted between the network entity 305-b and the UE 315-c (or both). Accordingly, the reception timing of the UE 315-b and the transmission timing of the UE 315-a or the UE 315-c (or both) may be misaligned and cause inaccuracies in CLI measurement performed at the UE 315-b.

In some examples, however, one or more of the UEs 315 may support a framework for aligning a transmission timing used for transmission of CLI reference signals with a reception timing used for CLI measurements. For example, to support lower layer (e.g., L1) UE-to-UE CLI measurements (e.g., aperiodic UE-to-UE CLI measurements) in which an uplink UE transmission (e.g., a transmission from an aggressor UE) and downlink UE reception (e.g., a reception at a victim UE) may have misaligned timing, the victim UE may use one or more aspects of techniques for inter-device CLI measurements, as described herein, to adjust the reception timing of the victim UE. Additionally, or alternatively, the aggressor UE may use one or more aspects of techniques for inter-device CLI measurements, as described herein, to adjust the transmission timing of the aggressor UE. In some examples, enabling one or more of the UEs 315 to align a transmission timing used for transmission of CLI reference signals with a reception timing used for CLI measurements of the CLI reference signals may lead to increased communication reliability within a wireless communications system, among other possible benefits.

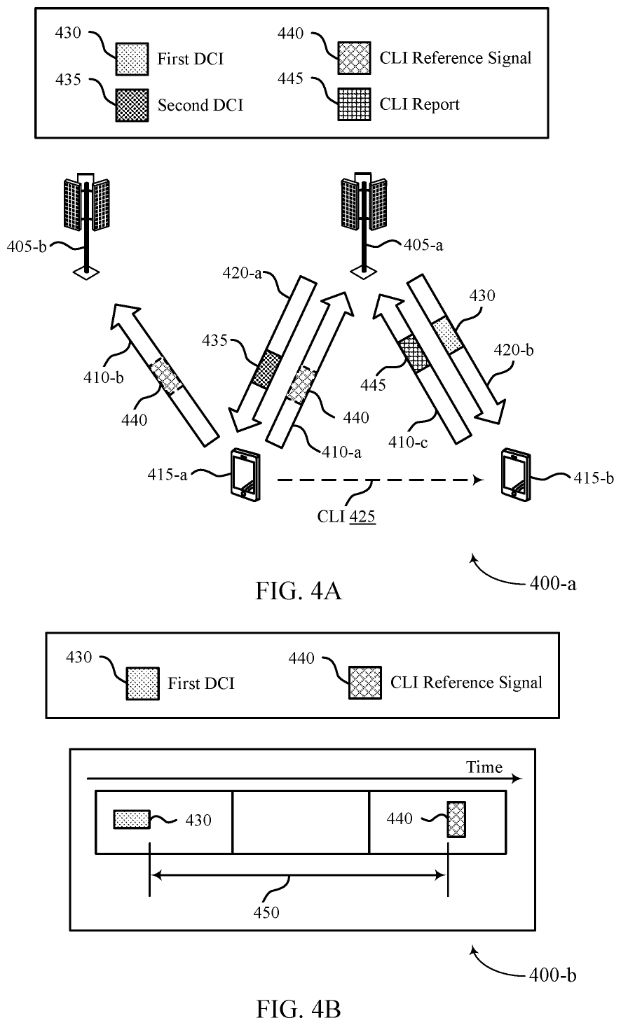

FIG. 4A illustrates an example of a wireless communications system 400-a that supports techniques for inter-device CLI measurements in accordance with one or more aspects of the present disclosure. The wireless communications system 400-a may implement or be implemented to realize or facilitate aspects of the wireless communications system 100, the wireless communications system 200, and the interference measurement diagram 300. For example, the wireless communications system 400-a includes a UE 415-a and a UE 415-b, which may be examples of UEs illustrated by and described with reference to FIGS. 1 and 2. Additionally, the wireless communications system 400-a includes a network entity 405-a and a network entity 405-b, which may be examples of network entities illustrated by and described with reference to FIGS. 1 and 2. The network entities 405 may communicate with one or more of the UEs 415 via one or more communication links. For example, the network entity 405-a may communicate with the UE 415-a via an uplink 410-a and a downlink 420-a. Additionally, the network entity 405-a may communicate with the UE 415-b via an uplink 410-c and a downlink 420-b. The network entity 405-b may communicate with the UE 415-a via an uplink 410-b. In some examples, the uplinks 410 and the downlinks 420 may each be an example of a communication link 125 (e.g., a Uu interface) illustrated by and described with reference to FIG. 1.

In some examples of the wireless communications system 400-a, one or both of the network entities 405 may support SBFD or dynamic TDD operations in which one or both of the network entities 405 may simultaneously or concurrently transmit downlink signals and receive uplink signals. For example, the UE 415-a may transmit uplink signaling to the network entity 405-a while the UE 315-b simultaneously receives downlink signaling from the network entity 405-a. In some other examples, the UE 415-a may transmit uplink signaling to the network entity 405-b while the UE 315-b receives downlink signaling from the network entity 405-a. The uplink signaling transmitted from the UE 415-a (e.g., an aggressor UE) may cause CLI 425 (e.g., inter-cell CLI or intra-cell CLI) at the UE 415-b.

To reduce CLI 425 and improve decoding of downlink signals at the UE 415-b, the network entity 405-a may configure the UE 415-b to perform one or more CLI measurements (e.g., one or more RSRP measurements or one or more RSSI measurements) using one or more reference signals transmitted by the UE 415-b (e.g., to the network entity 405-a or the network entity 405-b). In such an example, the network entity 405-a may transmit control signaling to the UE 415-b that triggers the UE 415-b to perform one or more CLI measurements (e.g., one or more UE-to-UE CLI measurements. For example, the network entity 405-a may transmit downlink control information (DCI) that indicates a resource (e.g., a time-frequency resource) that the UE 415-b may use to measure CLI experienced at the UE 415-b due to signaling from the UE 415-a. The resource may correspond to a resource that the UE 415-a may be scheduled to use for transmission of an uplink reference signal (e.g., a CLI reference signal, such as an SRS) to the network entity 405-a or the network entity 405-b. That is, the resource (e.g., a UE-to-UE CLI measurement resource) may correspond to (or be associated with) a CLI reference signal resource.

As illustrated in the example of FIG. 4A, the network entity 405-a may transmit a first DCI 430 to the to the UE 415-b. The first DCI 430 my indicate a UE-to-UE CLI measurement resource that the UE 415-b may use to perform one or more UE-to-UE CLI measurements. In such an example, the UE 415-b may use a reception timing to determine when to perform the UE-to-UE CLI measurements for the indicate UE-to-UE CLI measurement resource. In some examples, the reception timing used at the UE 415-b may be based on a propagation delay associated with the UE 415-b. For example, propagation delay may refer to a time duration between transmission of a signal from a transmitting device and reception of the signal at a receiving device. The propagation delay may be based on a distance between the transmitting device and the receiving device, an environment of the transmitting device, an environment of the receiving device, or any combination thereof, among other examples of factors that may impact a propagation delay. As such, the UE 415-b may apply a reception timing based on the propagation delay experienced at the UE 415-b to determine when to perform the UE-to-UE CLI measurements for the indicate UE-to-UE CLI measurement resource.

Additionally, the network entity 405-a or the network entity 405-b may transmit control signaling to the UE 415-a that triggers the UE 415-a to transmit one or more UE-to-UE CLI reference signals. For example, the network entity 405-a may transmit a second DCI 435 to the UE 415-a that indicates a resource (e.g., a time-frequency resource, a UE-to-UE CLI reference signal resource) that the UE 415-a may use to transmit one or more UE-to-UE CLI reference signals (e.g., for the UE-to-UE CLI measurements at the UE 415-b). In some examples, the UE 415-a may use a transmission timing to determine when to transmit the UE-to-UE CLI reference signal (e.g., based on the indicated UE-to-UE CLI reference signal resource). In such examples, the transmission timing may be based on a propagation delay experienced at the UE 415-a. In some examples, however, the propagation delay experienced at the UE 415-b may be different from the propagation delay experienced at the UE 415-a. Accordingly, the reception timing used at the UE 415-b and the transmission timing used at the UE 415-a may be misaligned, which may lead to inaccuracies in the UE-to-UE CLI measurement performed at the UE 415-b.

To support lower layer (e.g., L1) UE-to-UE CLI measurements, such as aperiodic UE-to-UE CLI measurements, the UE 415-b may implement one or more aspects of techniques for inter-device CLI measurements, as described herein, to adjust the reception timing of the UE 415-b to align with the transmission timing of the UE 415-a. That is, uplink transmissions from the UE 415-a and downlink receptions at the UE 415-b may have misaligned timing. In some examples, such as examples in which the UE 415-a may refrain from adjusting (e.g., changing) the transmission timing of the UE 415-a and the reception timing and the transmission timing are misaligned, the UE 415-b may use a time interval to adjust the reception timing to align with the transmission timing of the UE 415-a for the UE-to-UE CLI measurements. In other words, if the aggressor UE (e.g., the UE 415-a) refrains from changing the transmission timing (e.g., an uplink timing advance timing), and if the timing is misaligned between the aggressor uplink UE and the victim downlink UE (e.g., the UE 415-b), the victim downlink UE may use a gap time (e.g., the time interval, a delta time gap) to adjust the reception timing to align with the transmission timing of the uplink UE (e.g., the transmission timing of the aggressor UE) for the UE-to-UE CLI measurements.

The UE 415-b may be configured with a rule to align the reception timing used at the UE 415-b for UE-to-UE CLI measurements with the transmission timing used at the UE 415-a for transmission of the UE-to-UE CLI reference signals. Accordingly, the UE 415-b may adjust the reception timing of the UE 415-b for the one or more UE-to-UE CLI measurements triggered via the first DCI 430 in accordance with the rule. In some examples, the rule may indicate for the UE 415-b to adjust the reception timing by applying a timing offset that is based on the rule. For example, in accordance with the rule, the UE 415-b may adjust the reception timing based on a timing advance offset configured at the UE 415-b. That is, the timing offset may include a timing advance of the UE 415-a for uplink transmissions (or downlink receptions). For example, the network entity 405-a may configure the UE 415-b (or the UE 415-b may be otherwise configured) with a timing advance offset to use for reception of downlink signaling from the network entity 405-a or transmission of uplink signaling to the network entity 405-a (or both). The network entity 405-a may configure the UE 415-b with the timing advance offset via a timing advance command. In such an example, the UE 415-b may use the configured timing advance offset to adjust the reception timing of the UE 415-b for the UE-to-UE CLI measurements. In other words, the victim UE may use its own timing advance to adjust the reception timing of the UE 415-a for the UE-to-UE CLI measurements.

In some examples, the UE 415-b may use the timing advance configured at the UE 415-b based on determining that a distance between the UE 415-a and the UE 415-b satisfies a threshold distance. That is, the victim UE may use its timing advance to adjust the reception timing based on the aggressor UE and victim UE being relatively close to each other. In other words, a respective timing advance for each of the UEs 415 may be based on a respective propagation delay from the network entity 405-a to each of the UEs 415. As such, if the UE 415-a and the UE 415-b are relatively close to each other, the timing advance for the UE 415-a may be relatively similar to the timing advance for the UE 415-b. Accordingly, the timing offset used at the UE 415-b to adjust the reception timing may be based on the timing advance for the UE 415-b, which may be similar to the timing advance for the UE 415-a (e.g., that the UE 415-a may apply for transmission of the UE-to-UE CLI reference signal). In other words, if the victim UE and aggressor UE are relatively close to each other and timing advance is relatively similar to each other, the timing offset applied to the reception timing of the victim UE could be based on the timing advance for the victim UE (which is similar to the timing advance for the aggressor UE). In some examples, the UE 415-b may determine that the UE 415-a and the UE 415-b are relatively close to each other based on measuring CLI reference signals in accordance with the timing advance of the UE 415-b prior to the downlink frame timing (e.g., for the configured UE-to-UE CLI measurements).

In some other examples, in accordance with the rule, the UE 415-b may adjust the reception timing of the UE 415-b for the UE-to-UE CLI measurements based on a timing advance offset configured at the UE 415-a. That is, the timing offset may include a timing advance associated with the UE 415-b (e.g., for uplink transmissions). In some examples, the network entity 405-a may indicate the timing advance of the UE 415-a to the UE 415-b. That is, the network entity 405-a may indicate the timing advance of the aggressor UE to the victim UE.

In some examples, the network entity 405-a may configure the UE 415-b (or the UE 415-b may be otherwise configured) with the timing offset. For example, the network entity 405-a may configure the UE 415-b to use the timing advance offset of the UE 415-b (e.g., a timing advance offset associated with a transmission timing of the UE 415-b) or the timing advance offset of the UE 415-a (e.g., a timing advance offset associated with the transmission timing of the UE 415-a). In some examples, the UE 415-b may adjust a fast Fourier transform (FFT) window (e.g., a processing window) used at the UE 415-b for the CLI measurement (e.g., in accordance with the rule). That is, the victim UE may adjust its FFT window for UE-to-UE CLI measurements.

In some examples, the UE 415-b may adjust the reception timing to a default state (e.g., may revert a prior adjustment to the reception timing) subsequent to performing the UE-to-UE CLI measurements. For example, in accordance with the rule, the UE 415-b may adjust the reception timing (or a transmission timing) at the UE 415-b before and after performing the UE-to-UE CLI measurements. In other words, the UE 415-b may use a timing adjusted in accordance with the rule to perform the UE-to-UE CLI measurements and may use another timing for reception of downlink signals (or transmission of uplink signals). Accordingly, the UE 415-b may adjust the transmission timing of the UE 415-b for uplink transmissions or another reception timing of the UE 415-b for downlink receptions in accordance with the rule. In some examples, the UE 415-b may be configured with a time interval (e.g., a gap, a quantity of symbols) before or after the UE-to-UE CLI measurements to adjust the other reception timing at the UE 415-b for downlink receptions or the uplink timing at the UE 415-b for uplink transmissions. Additionally, in some examples, the UE 415-b may request to be configured with the time interval. In other words, the victim UE may be configured (e.g., may request to be configured) with one or more gap symbols before and after a CLI reference signal symbol (e.g., a last CLI reference signal symbols) to adjust its uplink timing (or downlink timing) back to a default operation (e.g., a default downlink operation or default uplink operation) or to adjust the aggressor UE's uplink timing (or downlink timing) back to a default operation (e.g., a default downlink operation or default uplink operation).

FIG. 4B illustrates an example of a timing diagram 400-b that supports techniques for inter-device CLI measurements in accordance with one or more aspects of the present disclosure. The timing diagram 400-b may implement or be implemented to realize or facilitate aspects of the wireless communications system 100, the wireless communications system 200, the interference measurement diagram 300, and the wireless communications system 400-a. For example, the timing diagram 400-b illustrates a timing of potential signaling between various wireless communication devices, including the UEs 415 and the network entities 405 illustrated by and described with reference to FIG. 4A.

As illustrated in the example of FIG. 4B, the UE 415-b may perform the adjustment to the reception timing of the UE 415-b for performing the UE-to-UE CLI measurements during a time interval 450. That is, the UE 415-b may use the time interval 450 to adjust the reception timing of the UE 415-b for one or more UE-to-UE CLI measurements using the CLI reference signal 440. For example, the UE 415-b may receive the first DCI 430 from the network entity 405, which may trigger reception of one or more UE-to-UE CLI reference signals for one or more UE-to-UE CLI measurements at the UE 415-b. The time interval 450 may occur after the UE 415-b receives the first DCI 430. Accordingly, the UE 415-b may use the time interval 450 to adjust the reception timing to align with the transmission timing of the UE 415-a for UE-to-UE CLI measurement. The time interval 450 may be based on the rule. For example, the UE 415-b may be configured with a rule that the UE 415-b may use to perform the UE-to-UE CLI measurements. In some examples, the rule may be defined at the network entity 405-a and indicated to the UE 415-b or the rule may be otherwise configured at the UE 415-b. In other words, the victim downlink UE may use a gap time (e.g., the time interval 450) to adjust its receiving timing to align with the transmission timing of the aggressor uplink UE for UE-to-UE CLI measurements. Accordingly, the network entity 405-a (e.g., a gNB) may define a rule (or configure the gap time, which may also be referred to as a delta gap time) for the victim UE to perform measurements (e.g., to perform L1 aperiodic, periodic, or semi-persistent CLI measurements). That is, the network entity 405-a (e.g., a gNB) may configure the UE 415-b with a time interval 450 (e.g., the delta gap time) between a first DCI 430 (e.g., an aperiodic CLI triggering DCI) and a CLI reference signal 440 (e.g., a CLI reference signal measurement resource).

The UE 415-b may be configured with a rule that may enable the UE 415-b (e.g., the victim UE) to determine (e.g., in advance of receiving the first DCI 430) one or more behaviors of the UE 415-b for UE-to-UE CLI measurements. For example, the UE 415-b may receive the first DCI 430 via a first time-domain resource and the first DCI 430 may indicate a second time-domain resource (e.g., corresponding to the CLI reference signal 440) for the one or more UE-to-UE CLI measurements. In accordance with the rule, the second time-domain resource may occur after the time interval 450. For example, the rule may indicate that UE 415-b may not expect the first DCI 430 (e.g., the aperiodic CLI triggering DCI) to schedule the CLI reference signal 440 (e.g., a CLI reference signal measurement resource) in the same slot. That is, the rule may indicate that the first time-domain resource (e.g., during which the UE 415-b may receive the first DCI 430) occurs in a first slot and the second time-domain resource (e.g., during which the CLI reference signal 440 may be scheduled) occurs in a second slot different from (e.g., subsequent to) the first slot. In some other examples, the rule may indicate the UE 415-b may not expect the first DCI 430 (e.g., the aperiodic CLI triggering DCI) to schedule the CLI reference signal 440 (e.g., the CLI-RS measurement resource) with a time interval (e.g., a gap) less than the time interval 450 (e.g., the delta gap time). In other words, the rule indicates that a difference between the first time-domain resource (e.g., during which the UE 415-b may receive the first DCI 430) and the second time-domain resource (e.g., during which the CLI reference signal 440 may be scheduled) satisfies a threshold that may be based on the time interval 450. In some examples, the rule may enable the UE 415-b to adjust the reception timing of the UE 415-b for the one or more UE-to-UE CLI measurements. That is, the time interval 450 may provide the victim UE with time to adjust its reception timing for CLI measurements. For example, the UE 415-b may use the time interval 450 to adjust the FFT window at the UE 415-b from a first FFT window that may be based on a downlink timing and used for reception of the first DCI 430 to a second FFT window that may be based on the adjusted reception timing (e.g., may be based on an uplink timing of the UE 415-a used for transmission of the CLI reference signal 440) and used for CLI measurement.

The time interval 450 may include a quantity (N) of symbols, a quantity (M) of slots, or a quantity (K) of ms. In some examples, the time interval 450 may include (e.g., span, occupy) a quantity (N) of symbols, a quantity (M) of slots, or a quantity (K) of ms subsequent to reception of the first DCI 430 (e.g., the CLI triggering DCI) at the UE 415-b or transmission of the first DCI 430 from the network entity 405-a. In some examples, the UE 415-b may transmit an acknowledgment message to the network entity 405-a in response to the first DCI 430 (e.g., in response to successful reception and decoding of the first DCI 430). In such an example, the time interval 450 may include a quantity (N) of symbols, a quantity (M) of slots, or a quantity (K) of ms subsequent to the reception of the acknowledgment message at the network entity 405-a or transmission of the acknowledgment message from the UE 415-b. In some examples, such as example in which the time interval 450 includes N symbols or M slots, a subcarrier spacing associated with the time interval 450 may depend on a subcarrier spacing associated with the first DCI 430 or the acknowledgment message. Alternatively, in such examples, a subcarrier spacing applied for the time interval 450 may correspond to a downlink or uplink BWP subcarrier spacing. In some examples, the network entity 405 may indicate the time interval 450 to the UE 415-b, for example, via the first DCI 430. That is, the time interval 450 may be indicated via the CLI triggering DCI. In some instances, the time interval 450 may be based on one or more UE capabilities (e.g., one or more capabilities associated with the UE 415-b, or the UE 415-a, or both).

The UE 415-b may perform the one or more UE-to-UE CLI measurements using the adjusted reception timing in accordance with the rule. For example, the UE 415-b may use the adjusted reception timing to perform the one or more UE-to-UE CLI measurements based on the CLI reference signal 440. As illustrated in the example of FIG. 4A, the UE 415-a may transmit the CLI reference signal 440 to the network entity 405-a via the uplink 410-a or to the network entity 405-b via the uplink 410-b. In some examples, the UE 415-b may transmit a CLI report 445 (e.g., an L1 CLI report) to the network entity 405-a that indicates one or more CLI metrics corresponding to the one or more CLI measurements.

Additionally, or alternatively, the UE 415-a may implement one or more aspects of techniques for inter-device CLI measurements, as described herein, to adjust the transmission timing of the UE 415-a to align with the reception timing of the UE 415-b. In other words, to support L1 UE-to-UE CLI measurements (e.g., aperiodic measurements) the aggressor UE (e.g., the UE 415-a) may adjust (e.g., change) an uplink timing advance time such that a CLI reference signal timing (e.g., a timing of the CLI reference signal 440) may be aligned within the downlink timing at the victim UE (e.g., the reception timing of the UE 415-b). In such examples, the victim UE may refrain from adjusting (e.g., change) its reception timing (e.g., its FFT window) for the CLI measurement.

For example, the UE 415-a may receive the second DCI 435 from the network entity 405-a. Although the example of FIG. 4A illustrates the UE 415-a receiving the second DCI 435 from the network entity 405-a, in some examples, the UE 415-a may receive the second DCI 435 from the network entity 405-b. The second DCI 435 may trigger a transmission of one or more UE-to-UE CLI reference signals. For example, the second DCI 435 may trigger (e.g., schedule) the UE 415-a to transmit the CLI reference signal 440.

In some examples, the UE 415-a may adjust the transmission timing of the UE 415-a for the transmission of the CLI reference signal 440 based on a rule to align the transmission timing with the reception timing of the UE 415-b. For example, the rule may configure the UE 415-a to adjust the transmission timing based on a timing advance offset associated with (e.g., for) the UE-to-UE CLI measurements. For example, the UE 415-a may receive an indication of (or may be otherwise configured with) a timing advance offset associated with transmission of the CLI reference signal 440 (e.g., for UE-to-UE CLI measurements at the UE 415-b). In other words, the network entity 405-a may indicate, to the aggressor UE, a timing advance adjustment to be applied for (e.g., that corresponds to) CLI reference signal transmissions. In some examples, the indicated timing advance offset may be based on a recommendation from the UE 415-b. For example, the UE 415-b may transmit, to the network entity 405-a, an indication of a recommended timing offset for adjustment of the transmission timing of the UE 415-a. In other words, the victim UE may request (or suggest) a timing advance adjustment for the aggressor UE to the network. In some examples, the requested (or suggested) recommended timing offset from the UE 415-b may be based on measurements performed at the UE 415-b (e.g., its measurement of timing).

In some examples, the rule may configure the UE 415-a to adjust the transmission timing of the UE 415-a for transmission of UE-to-UE CLI reference signals autonomously. For example, the rule may configure or enable the UE 415-a to autonomously adjust the transmission timing of the UE 415-a in accordance with the rule to align the transmission timing of the UE 415-a with a reception timing of the UE 415-a for downlink receptions. In other words, based on the rule, the transmission timing of the aggressor UE may be adjusted autonomously by the aggressor UE to align its uplink timing with the downlink timing of the aggressor UE. In some examples, the rule may indicate that the UE 415-a may adjust the transmission timing autonomously based on a distance between the UE 415-a and the UE 415-b satisfying a threshold (e.g., that the UE 415-a and the UE 415-b are relatively close to each other). That is, the aggressor UE may autonomously adjust the transmission timing of the aggressor UE if the downlink timing of the aggressor UE and a downlink timing of the victim UE is relatively similar (e.g., the same), or a propagation delay between the UEs 415 is relatively small, or both. The UE 415-a may determine that the UE 415-a and the UE 415-b are relatively close to each other based on one or more measurements performed at the UE 415-a. Additionally, in some examples, the UE 415-a may adjust the transmission timing by refraining from applying a timing advance adjustment configured at the UE 415-a for uplink transmissions. That is, the aggressor UE may refrain from applying a timing advance offset (e.g., and the timing advance) for transmission of uplink CLI reference signals.

In some examples, the UE 415-a may adjust the transmission timing to a default state (e.g., may revert a prior adjustment to the transmission timing) subsequent to transmitting the CLI reference signal 440. For example, in accordance with the rule, the UE 415-a may adjust the transmission timing (or a reception timing) at the UE 415-a before and after transmitting one or more UE-to-UE CLI reference signals. In other words, the UE 415-a may use a timing adjusted in accordance with the rule to transmit the UE-to-UE CLI reference signals and may use another timing for transmission of other uplink signals (e.g., to the network entity 405-a), or reception of downlink signals (e.g., from the network entity 405-a), or both. Accordingly, the UE 415-a may adjust another transmission timing of the UE 415-a for uplink transmissions or a reception timing of the UE 415-a for downlink receptions in accordance with the rule.

In some examples, the UE 415-a may be configured with a time interval (e.g., a gap, a quantity of symbols) before or after transmission of the UE-to-UE CLI reference signals (e.g., the CLI reference signal 440) to adjust the reception timing for downlink receptions or the other uplink timing for uplink transmissions. Additionally, in some examples, the UE 415-a may request to be configured with the time interval. In other words, the aggressor UE may request or be configured (e.g., by the network entity) with one or more gap symbols (e.g., the time interval) before and after a CLI reference signal symbol to adjust its downlink timing (or uplink timing) back to a default operation or to adjust the victim UE's downlink timing (or uplink timing) back to the default operation. The CLI reference signal symbol may include a last CLI reference signal symbol, such as a symbol used at the UE 415-a for transmission of the CLI reference signal 440. In some examples, the default operation may correspond to a default uplink operation or a default downlink operation. In some examples, enabling alignment of a transmission timing used for transmission of CLI reference signals with a reception timing used for CLI measurements of the CLI reference signals may lead to increased communication reliability and reduced latency within the wireless communications system 400-a, among other possible benefits.

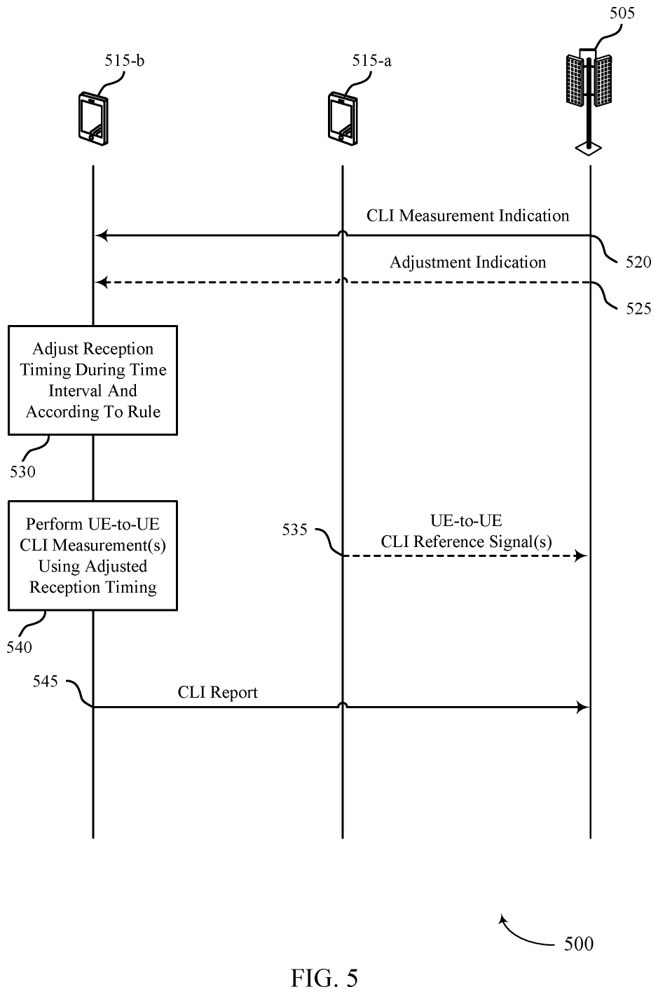

FIG. 5 illustrates an example of a process flow 500 that supports techniques for inter-device CLI measurements in accordance with one or more aspects of the present disclosure. The process flow 500 may implement or be implemented to facilitate or realize one or more aspects of the wireless communications system 100, the wireless communications system 200, the interference measurement diagram 300, the wireless communications system 400-a, and the timing diagram 400-b. For example, the process flow 500 may be implemented at a UE 515-a and a UE 515-b, which may be examples of a UE illustrated by and described with reference to FIGS. 1, 2, 3, 4A, and 4B. Additionally, the process flow 500 may be implemented at a network entity 505, which may be an example of a network entity illustrated by and described with reference to FIGS. 1, 2, 3, 4A, and 4B. The operations performed at the UEs 515 (e.g., UE 515-a, UE 515-b) and the network entity 505 may support improvements to communications between the UEs 515 and the network entity 505, among other benefits. In the following description of the process flow 500, the operations performed at the UEs 515 and the network entity 505 may occur in a different order than the example order shown. Additionally, the operations performed at the UEs 515 and the network entity 505 may be performed at different times. Some operations may be combined and some operations may be omitted. In some examples, the UEs 515 and the network entity 505 may support a framework for aligning a reception timing used for performing UE-to-UE CLI measurements with a transmission timing used for transmission of UE-to-UE CLI reference signals.

In some examples, the UE 515-b may adjust a reception timing used at the UE 515-b for performing UE-to-UE CLI measurements using UE-to-UE CLI reference signals. In such examples, the UE 515-a may refrain from adjusting a transmission timing used at the UE 515-a for transmission of UE-to-UE CLI reference signals. For example, the UE 515-b may be configured with a rule for adjusting the reception timing to align with the transmission timing of the UE 515-a.

At 520, the UE 515-b may receive a CLI measurement indication. The CLI measurement indication (e.g., a control message) may be an example of a first DCI illustrated by and described with reference to FIG. 4A. For example, the CLI measurement indication may trigger reception of one or more UE-to-UE CLI reference signals for one or more UE-to-UE CLI measurements at the UE 515-b.

At 530, the UE 515-b may adjust a reception timing of the UE 515-b for the one or more UE-to-UE CLI measurements. For example, the UE 515-b may adjust the reception timing during a time interval and according to a rule. The time interval may be an example of a time interval illustrated by and described with reference to FIG. 4B. For example, the time interval may occur after UE 515-b receives the CLI measurement indication (e.g., the first DCI). Additionally, the rule may be an example of a rule described with reference to FIGS. 4A and 4B. For example, the rule may be an example of a rule to align the reception timing of the UE 515-b with a transmission timing of the UE 515-a (e.g., a transmission timing associated with transmission of the one or more UE-to-UE CLI reference signals from the UE 515-a).

In some examples, the rule may configure the UE 515-b to adjust the reception timing by applying a timing offset that may be based on the rule. The timing offset may include a timing advance offset of the UE 515-b for uplink transmissions or a timing advance offset of the UE 515-b. In some other examples, the UE 515-b may receive an indication of the timing offset from the network entity 505.

For example, at 525, the UE 515-b may receive an adjustment indication from the network entity 505. The adjustment indication may indicate the timing offset in accordance with the rule.

At 540, the UE 515-b may perform the one or more UE-to-UE CLI measurements using the adjusted reception timing in accordance with the rule. The UE-to-UE CLI measurements may be examples of UE-to-UE CLI measurements illustrated by and described with reference to FIG. 3. For example, the UE-to-UE CLI measurements may include RSSI measurements or RSRP measurements.

The one or more UE-to-UE CLI measurements may be associated with a half-duplex operation mode at the UE 515-b. Additionally, the one or more UE-to-UE CLI measurements may be associated with a full-duplex operation mode at the network entity 505, a SBFD operation mode at the network entity 505, or a half-duplex operation mode (e.g., dynamic TDD) at the network entity 505 (e.g., and with a misaligned slot format).

In some examples, at 535, the UE 515-a may transmit the one or more UE-to-UE CLI reference signals to the network entity 505, such that the UE 515-b may use the one or more UE-to-UE CLI reference signals to perform the one or more UE-to-UE CLI measurements. In some examples, a UE-to-UE CLI reference signal may include an SRS.

At 545, the UE 515-b may transmit a CLI report to the network entity 505. The CLI report may be an example of a CLI report illustrated by and described with reference to FIG. 4A. For example, the CLI report may indicates one or more CLI metrics corresponding to the one or more UE-to-UE CLI measurements. In some examples, a CLI metric may include and an RSSI (e.g., an L1-RSSI) or an RSRSP (e.g., an L1-RSRP). Adjusting the reception timing of the UE 515-b to align with the transmission timing of the UE 515-a may enable the UE 515-b to increase a performance of CLI measurement and reporting, among other possible benefits.

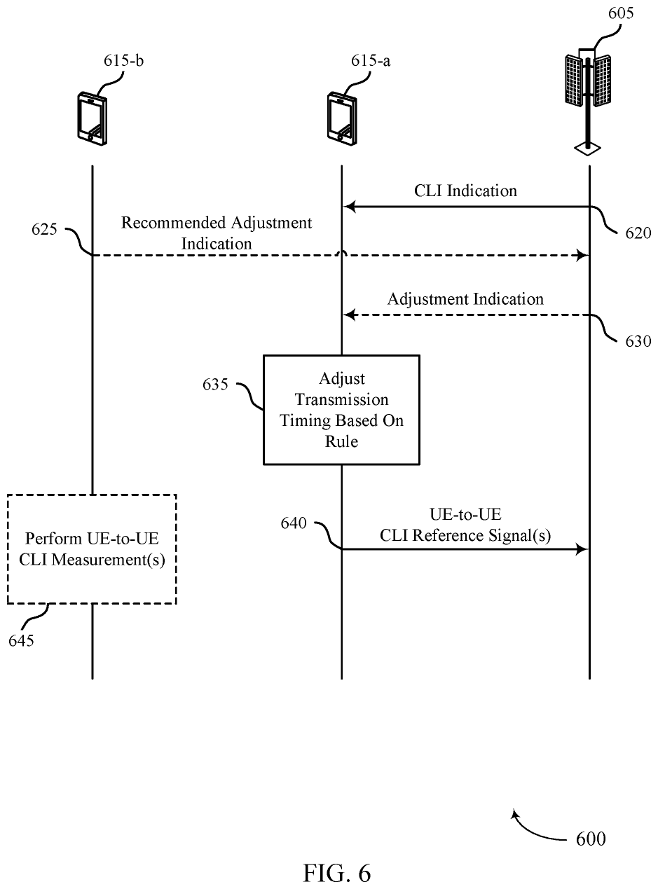

FIG. 6 illustrates an example of a process flow 600 that supports techniques for inter-device CLI measurements in accordance with one or more aspects of the present disclosure. The process flow 600 may implement or be implemented to facilitate or realize one or more aspects of the wireless communications system 100, the wireless communications system 200, the interference measurement diagram 300, the wireless communications system 400-a, the timing diagram 400-b, and the process flow 500. For example, the process flow 600 may be implemented at a UE 615-a and a UE 615-b, which may be examples of a UE illustrated by and described with reference to FIGS. 1, 2, 3, 4A, 4B, and 5. Additionally, the process flow 600 may be implemented at a network entity 605, which may be an example of a network entity illustrated by and described with reference to FIGS. 1, 2, 3, 4A, 4B, and 5. The operations performed at the UEs 615 (e.g., UE 615-a, UE 615-b) and the network entity 605 may support improvements to communications between the UEs 615 and the network entity 605, among other benefits. In the following description of the process flow 600, the operations performed at the UEs 615 and the network entity 605 may occur in a different order than the example order shown. Additionally, the operations performed at the UEs 615 and the network entity 605 may be performed at different times. Some operations may be combined and some operations may be omitted. In some examples, the UEs 615 and the network entity 605 may support a framework for aligning a reception timing used for performing UE-to-UE CLI measurements with a transmission timing used for transmission of UE-to-UE CLI reference signals.

In some examples, the UE 615-a may adjust a transmission timing used at the UE 615-a for transmitting UE-to-UE CLI reference signals. In such examples, the UE 615-b may refrain from adjusting a reception timing used at the UE 615-b for performing UE-to-UE CLI measurements (e.g., using the UE-to-UE CLI reference signals). For example, the UE 615-a may be configured with a rule for adjusting the transmission timing to align with the reception timing of the UE 615-b.

At 620, the UE 615-a may receive a CLI indication from the network entity 605. The CLI indication (e.g., a control message) may be an example of a second DCI illustrated by and described with reference to FIG. 4A. For example, the CLI indication may trigger a transmission of one or more UE-to-UE CLI reference signals at the UE 615-a.

At 635, the UE 615-a may adjust the transmission timing of the UE 615-a for the transmission of the one or more UE-to-UE CLI reference signals based on a rule. The rule may be an example of a rule illustrated by and described with reference to FIGS. 4A and 4B. For example, the rule may be to align the transmission timing with a reception timing of the UE 615-b (e.g., a reception timing associated with one or more UE-to-UE CLI measurements at the UE 615-b). In some examples, the rule may indicate for the UE 615-a to adjust the transmission timing by applying a timing offset.

For example, at 630, the UE 615-a may receive an adjustment indication from the network entity 605. The adjustment indication may indicate a timing advance offset associated with the transmission of the one or more UE-to-UE CLI reference signals. The timing advance offset may be based on the rule. In some examples, the timing advance offset may be based on a recommended timing advance indicated to the network entity 605 from the UE 615-b.

For example, at 625, the UE 615-b may transmit a recommended adjustment indication to the network entity 605. The recommended adjustment indication may indicate a recommended timing offset for adjustment of the transmission timing of the UE 615-a. In some examples, the recommended adjustment indication may be based on one or more measurements performed at the UE 615-b.

At 640, the UE 615-a may transmit the one or more UE-to-UE CLI reference signals to the network entity 605 using the adjusted transmission timing in accordance with the rule. The UE 615-a may transmit the one or more UE-to-UE CLI reference signals to the network entity 605, such that the UE 615-b may use the one or more UE-to-UE CLI reference signals to perform the one or more UE-to-UE CLI measurements.

For example, at 645, the UE 615-b may perform the one or more UE-to-UE CLI measurements using the UE-to-UE CLI reference signals transmitted from the UE 615-a. The UE-to-UE CLI measurements may include RSSI measurements or RSRP measurements. In some examples, the UE 615-a may transmit the one or more UE-to-UE CLI reference signals in accordance with a half-duplex operation mode at the UE 615-a. Additionally, the UE 615-a may transmit the one or more UE-to-UE CLI reference signals in accordance with a full-duplex operation mode at the network entity 605, a SBFD operation mode at the network entity 605, or a half-duplex operation mode (e.g., dynamic TDD) at the network entity 605 (e.g., and with a misaligned slot format). Adjusting the transmission timing of the UE 615-a to align with the reception timing of the UE 615-b may enable the UE 615-a to increase a performance of CLI measurement and reporting at the UE 615-b, among other possible benefits.

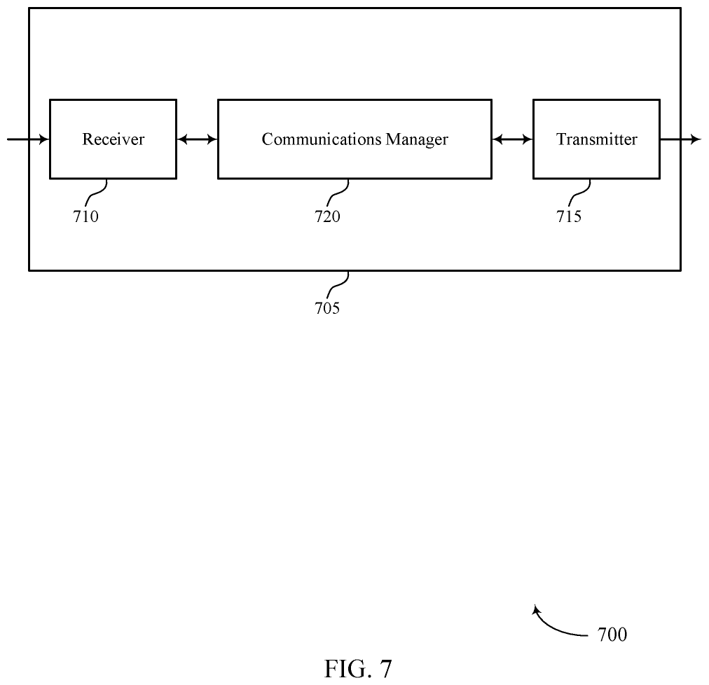

FIG. 7 illustrates a block diagram 700 of a device 705 that supports techniques for inter-device CLI measurements in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for inter-device CLI measurements). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for inter-device CLI measurements). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for inter-device CLI measurements as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE (e.g., the device 705) in accordance with examples as disclosed herein. For example, the communications manager 720 may be configured as or otherwise support a means for receiving, from a network entity, a control message that triggers reception of one or more UE-to-UE CLI reference signals for one or more UE-to-UE CLI measurements. The communications manager 720 may be configured as or otherwise support a means for adjusting a reception timing of the first UE for the one or more UE-to-UE CLI measurements, where the reception timing is adjusted during a time interval that occurs after the control message is received and in accordance with a rule to align the reception timing of the first UE with a transmission timing of a second UE (e.g., another device 705) that is associated with transmission of the one or more UE-to-UE CLI reference signals from the second UE. The communications manager 720 may be configured as or otherwise support a means for performing the one or more UE-to-UE CLI measurements using the adjusted reception timing in accordance with the rule. The communications manager 720 may be configured as or otherwise support a means for transmitting, to the network entity, a report that indicates one or more CLI metrics corresponding to the one or more UE-to-UE CLI measurements.

Additionally, or alternatively, the communications manager 720 may support wireless communication at a first UE (e.g., the other device 705) in accordance with examples as disclosed herein. For example, the communications manager 720 may be configured as or otherwise support a means for receiving, from a network entity, a control message that triggers a transmission of one or more UE-to-UE CLI reference signals. The communications manager 720 may be configured as or otherwise support a means for adjusting a transmission timing of the first UE for the transmission of the one or more UE-to-UE CLI reference signals based on a rule to align the transmission timing with a reception timing of a second UE (e.g., the device 705) that is associated with one or more UE-to-UE CLI measurements at the second UE. The communications manager 720 may be configured as or otherwise support a means for transmitting, to the network entity, the one or more UE-to-UE CLI reference signals using the adjusted transmission timing in accordance with the rule.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources.

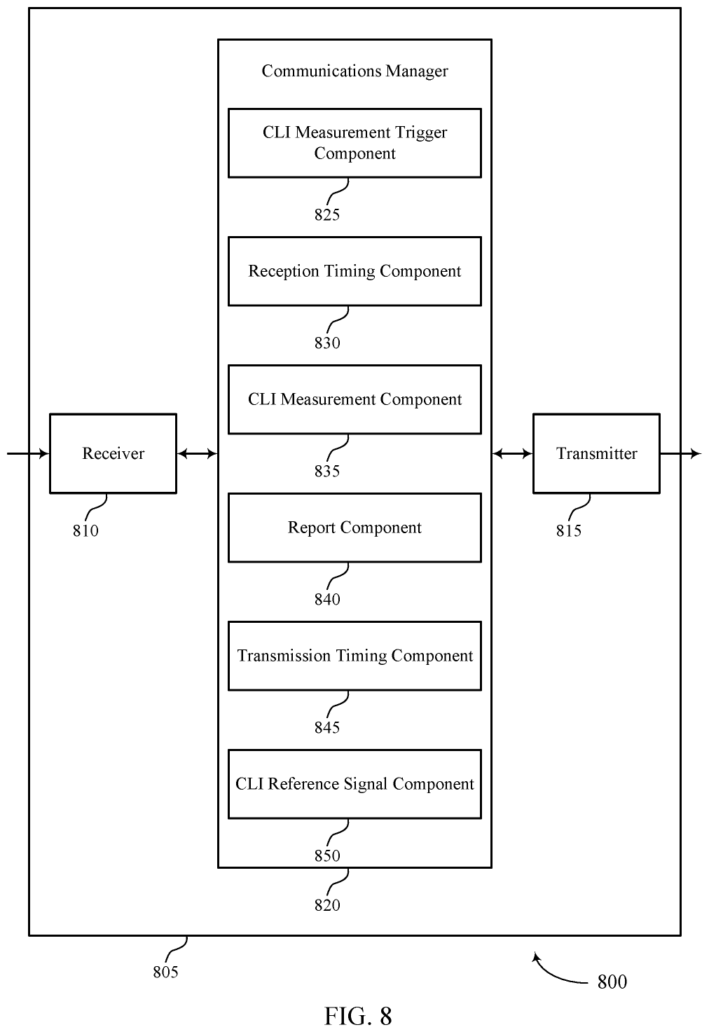

FIG. 8 illustrates a block diagram 800 of a device 805 that supports techniques for inter-device CLI measurements in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for inter-device CLI measurements). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for inter-device CLI measurements). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for inter-device CLI measurements as described herein. For example, the communications manager 820 may include a CLI measurement trigger component 825, a reception timing component 830, a CLI measurement component 835, a report component 840, a transmission timing component 845, a CLI reference signal component 850, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first UE (e.g., the device 805) in accordance with examples as disclosed herein. The CLI measurement trigger component 825 may be configured as or otherwise support a means for receiving, from a network entity, a control message that triggers reception of one or more UE-to-UE CLI reference signals for one or more UE-to-UE CLI measurements. The reception timing component 830 may be configured as or otherwise support a means for adjusting a reception timing of the first UE for the one or more UE-to-UE CLI measurements, where the reception timing is adjusted during a time interval that occurs after the control message is received and in accordance with a rule to align the reception timing of the first UE with a transmission timing of a second UE (e.g., another device 805) that is associated with transmission of the one or more UE-to-UE CLI reference signals from the second UE. The CLI measurement component 835 may be configured as or otherwise support a means for performing the one or more UE-to-UE CLI measurements using the adjusted reception timing in accordance with the rule. The report component 840 may be configured as or otherwise support a means for transmitting, to the network entity, a report that indicates one or more CLI metrics corresponding to the one or more UE-to-UE CLI measurements.

Additionally, or alternatively, the communications manager 820 may support wireless communication at a first UE (e.g., the other device 805) in accordance with examples as disclosed herein. The CLI measurement trigger component 825 may be configured as or otherwise support a means for receiving, from a network entity, a control message that triggers a transmission of one or more UE-to-UE CLI reference signals. The transmission timing component 845 may be configured as or otherwise support a means for adjusting a transmission timing of the first UE for the transmission of the one or more UE-to-UE CLI reference signals based on a rule to align the transmission timing with a reception timing of a second UE (e.g., the device 805) that is associated with one or more UE-to-UE CLI measurements at the second UE. The CLI reference signal component 850 may be configured as or otherwise support a means for transmitting, to the network entity, the one or more UE-to-UE CLI reference signals using the adjusted transmission timing in accordance with the rule.

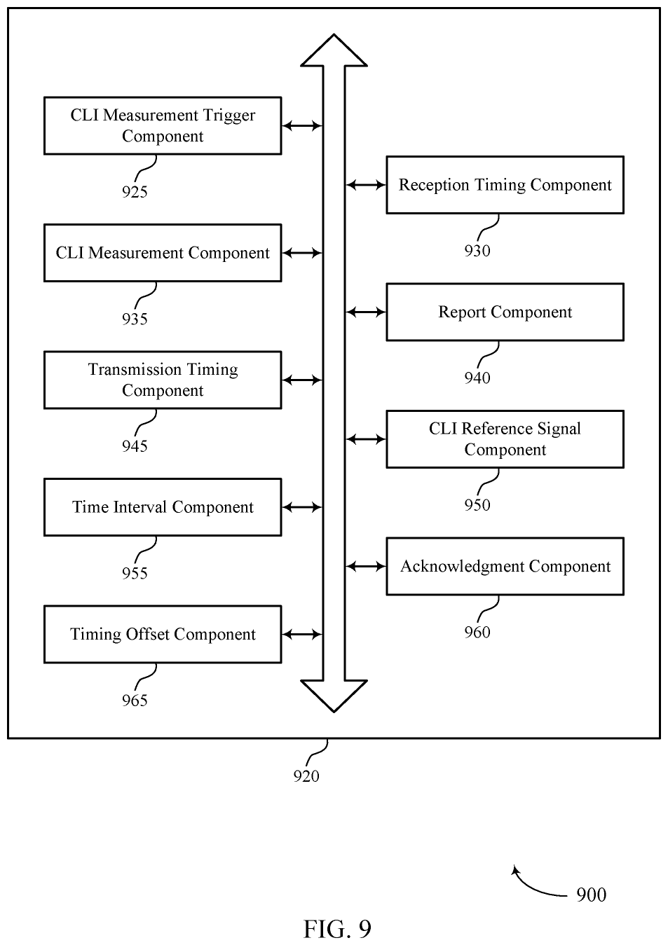

FIG. 9 illustrates a block diagram 900 of a communications manager 920 that supports techniques for inter-device CLI measurements in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for inter-device CLI measurements as described herein. For example, the communications manager 920 may include a CLI measurement trigger component 925, a reception timing component 930, a CLI measurement component 935, a report component 940, a transmission timing component 945, a CLI reference signal component 950, a time interval component 955, an acknowledgment component 960, a timing offset component 965, or any combination thereof. Each of these components may communicate, directly or indirectly, with one another (e.g., via one or more buses).

The communications manager 920 may support wireless communication at a first UE in accordance with examples as disclosed herein. The CLI measurement trigger component 925 may be configured as or otherwise support a means for receiving, from a network entity, a control message that triggers reception of one or more UE-to-UE CLI reference signals for one or more UE-to-UE CLI measurements. The reception timing component 930 may be configured as or otherwise support a means for adjusting a reception timing of the first UE for the one or more UE-to-UE CLI measurements, where the reception timing is adjusted during a time interval that occurs after the control message is received and in accordance with a rule to align the reception timing of the first UE with a transmission timing of a second UE that is associated with transmission of the one or more UE-to-UE CLI reference signals from the second UE. The CLI measurement component 935 may be configured as or otherwise support a means for performing the one or more UE-to-UE CLI measurements using the adjusted reception timing in accordance with the rule. The report component 940 may be configured as or otherwise support a means for transmitting, to the network entity, a report that indicates one or more CLI metrics corresponding to the one or more UE-to-UE CLI measurements.

In some examples, to support receiving the control message, the CLI measurement trigger component 925 may be configured as or otherwise support a means for receiving the control message via a first time-domain resource, where the control message indicates a second time-domain resource for the one or more UE-to-UE CLI measurements that occurs after the time interval in accordance with the rule.

In some examples, the rule indicates that the first time-domain resource occurs in a first slot and the second time-domain resource occurs in a second slot different from the first slot. In some examples, the rule indicates that a difference between the first time-domain resource and the second time-domain resource satisfies a threshold that is based on the time interval.

In some examples, the time interval component 955 may be configured as or otherwise support a means for receiving, from the network entity, an indication of the time interval in accordance with the rule. In some examples, the control message includes the indication of the time interval.

In some examples, the acknowledgment component 960 may be configured as or otherwise support a means for transmitting, to the network entity, an acknowledgment message responsive to the control message, where the time interval is based on the acknowledgment message. In some examples, the time interval is based on one or more capabilities of the first UE.

In some examples, to support adjusting the reception timing of the first UE, the reception timing component 930 may be configured as or otherwise support a means for adjusting the reception timing by applying a timing offset that is based on the rule.

In some examples, the timing offset includes a timing advance offset of the first UE for uplink transmissions. In some examples, the timing offset includes a timing advance offset of a second UE that is associated with the transmission timing.

In some examples, the timing offset component 965 may be configured as or otherwise support a means for receiving, from the network entity, an indication of the timing offset in accordance with the rule.

In some examples, the transmission timing component 945 may be configured as or otherwise support a means for adjusting a second transmission timing of the first UE for uplink transmissions or a second reception timing of the first UE for downlink receptions in accordance with a second time interval that occurs before or after the one or more UE-to-UE CLI measurements in accordance with the rule.

In some examples, the one or more UE-to-UE CLI measurements are associated with a half-duplex operation mode at the first UE. In some examples, the one or more UE-to-UE CLI measurements are associated with a full-duplex operation mode at the network entity. In some examples, the one or more UE-to-UE CLI measurements are associated with a SBFD operation mode at the network entity. In some examples, the one or more UE-to-UE CLI measurements are associated with a half-duplex operation mode at the network entity and with a misaligned slot format.

In some examples, the timing offset component 965 may be configured as or otherwise support a means for transmitting, to the network entity, an indication of a recommended timing offset for adjustment of the transmission timing of the second UE.

Additionally, or alternatively, the communications manager 920 may support wireless communication at a first UE in accordance with examples as disclosed herein. In some examples, the CLI measurement trigger component 925 may be configured as or otherwise support a means for receiving, from a network entity, a control message that triggers a transmission of one or more UE-to-UE CLI reference signals. The transmission timing component 945 may be configured as or otherwise support a means for adjusting a transmission timing of the first UE for the transmission of the one or more UE-to-UE CLI reference signals based on a rule to align the transmission timing with a reception timing of a second UE that is associated with one or more UE-to-UE CLI measurements at the second UE. The CLI reference signal component 950 may be configured as or otherwise support a means for transmitting, to the network entity, the one or more UE-to-UE CLI reference signals using the adjusted transmission timing in accordance with the rule.

In some examples, the timing offset component 965 may be configured as or otherwise support a means for receiving, from the network entity, an indication of a timing advance offset associated with the transmission of the one or more UE-to-UE CLI reference signals, where the timing advance offset is based on the rule, and where the transmission timing is adjusted in accordance with the timing advance offset.

In some examples, to support adjusting the transmission timing of the first UE, the transmission timing component 945 may be configured as or otherwise support a means for adjusting the transmission timing of the first UE in accordance with the rule to align the transmission timing of the first UE with a second reception timing of the first UE for downlink receptions.

In some examples, the reception timing component 930 may be configured as or otherwise support a means for adjusting a second reception timing of the first UE for downlink receptions or a second transmission timing of the first UE for uplink transmissions in accordance with a second time interval that occurs before or after the transmission of the one or more UE-to-UE CLI reference signals and based on the rule.

In some examples, the transmission of the one or more UE-to-UE CLI reference signals is in accordance with a half-duplex operation mode at the first UE. In some examples, the one or more UE-to-UE CLI measurements are associated with a full-duplex operation mode at the network entity. In some examples, the one or more UE-to-UE CLI measurements are associated with a SBFD operation mode at the network entity. In some examples, the one or more UE-to-UE CLI measurements are associated with a half-duplex operation mode at the network entity.

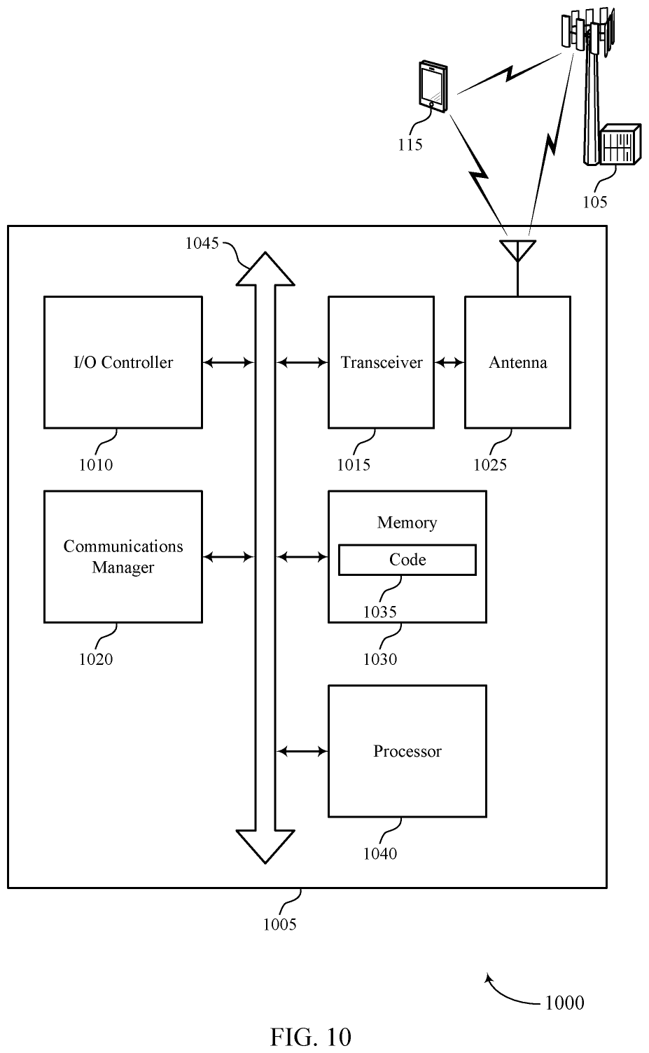

FIG. 10 illustrates a diagram of a system 1000 including a device 1005 that supports techniques for inter-device CLI measurements in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for inter-device CLI measurements). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first UE (e.g., the device 1005) in accordance with examples as disclosed herein. For example, the communications manager 1020 may be configured as or otherwise support a means for receiving, from a network entity, a control message that triggers reception of one or more UE-to-UE CLI reference signals for one or more UE-to-UE CLI measurements. The communications manager 1020 may be configured as or otherwise support a means for adjusting a reception timing of the first UE for the one or more UE-to-UE CLI measurements, where the reception timing is adjusted during a time interval that occurs after the control message is received and in accordance with a rule to align the reception timing of the first UE with a transmission timing of a second UE (e.g., another device 1005) that is associated with transmission of the one or more UE-to-UE CLI reference signals from the second UE. The communications manager 1020 may be configured as or otherwise support a means for performing the one or more UE-to-UE CLI measurements using the adjusted reception timing in accordance with the rule. The communications manager 1020 may be configured as or otherwise support a means for transmitting, to the network entity, a report that indicates one or more CLI metrics corresponding to the one or more UE-to-UE CLI measurements.

Additionally, or alternatively, the communications manager 1020 may support wireless communication at a first UE (e.g., the other device 1005) in accordance with examples as disclosed herein. For example, the communications manager 1020 may be configured as or otherwise support a means for receiving, from a network entity, a control message that triggers a transmission of one or more UE-to-UE CLI reference signals. The communications manager 1020 may be configured as or otherwise support a means for adjusting a transmission timing of the first UE for the transmission of the one or more UE-to-UE CLI reference signals based on a rule to align the transmission timing with a reception timing of a second UE (e.g., the device 1005) that is associated with one or more UE-to-UE CLI measurements at the second UE. The communications manager 1020 may be configured as or otherwise support a means for transmitting, to the network entity, the one or more UE-to-UE CLI reference signals using the adjusted transmission timing in accordance with the rule.

By including or configuring the communications manager 1020 in accordance with examples as described herein, the device 1005 may support techniques for improved communication reliability, reduced latency, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for inter-device CLI measurements as described herein, or the processor 1040 and the memory 1030 may be otherwise configured to perform or support such operations.

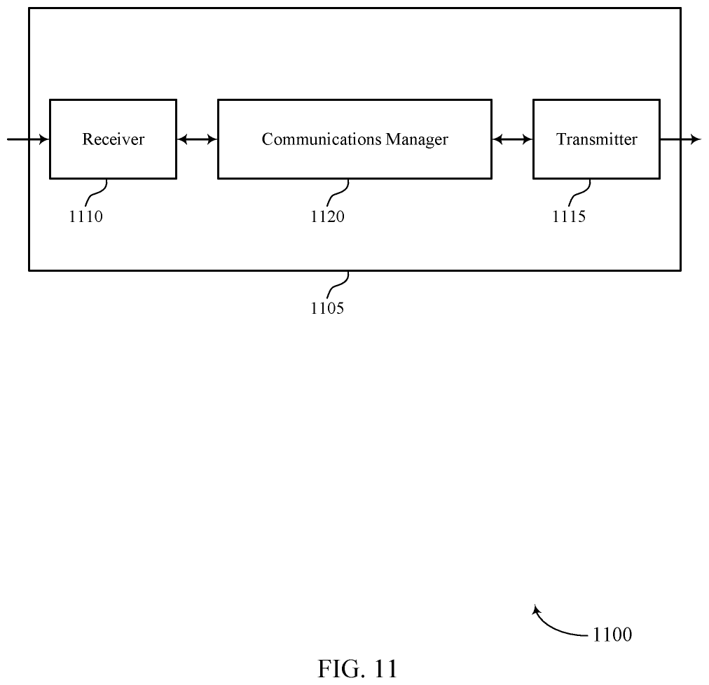

FIG. 11 illustrates a block diagram 1100 of a device 1105 that supports techniques for inter-device CLI measurements in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for inter-device CLI measurements as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity (e.g., the device 1105) in accordance with examples as disclosed herein. For example, the communications manager 1120 may be configured as or otherwise support a means for outputting a first indication that triggers reception of one or more UE-to-UE CLI reference signals for one or more UE-to-UE CLI measurements at a UE. The communications manager 1120 may be configured as or otherwise support a means for outputting a second indication of a time interval that occurs after the first indication is output from the network entity and that is based on a rule to align a reception timing of the first UE with a transmission timing of a second UE that is associated with transmission of the one or more UE-to-UE CLI reference signals from the second UE. The communications manager 1120 may be configured as or otherwise support a means for obtaining a report in response to the first indication, where the report indicates one or more CLI metrics corresponding to the one or more UE-to-UE CLI measurements.

Additionally, or alternatively, the communications manager 1120 may support wireless communication at a network entity (e.g., the device 1105) in accordance with examples as disclosed herein. For example, the communications manager 1120 may be configured as or otherwise support a means for outputting a first indication that triggers a transmission of one or more UE-to-UE CLI reference signals at a first UE. The communications manager 1120 may be configured as or otherwise support a means for outputting a second indication of a timing offset associated with a transmission timing of the first UE for the transmission of the one or more UE-to-UE CLI reference signals, the timing offset is based on a rule that aligns the transmission timing of the first UE with a reception timing of a second UE that is associated with one or more UE-to-UE CLI measurements at the second UE. The communications manager 1120 may be configured as or otherwise support a means for obtaining the one or more UE-to-UE CLI reference signals in accordance with the rule and an adjustment to the transmission timing of the first UE that is based on the timing offset.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources.

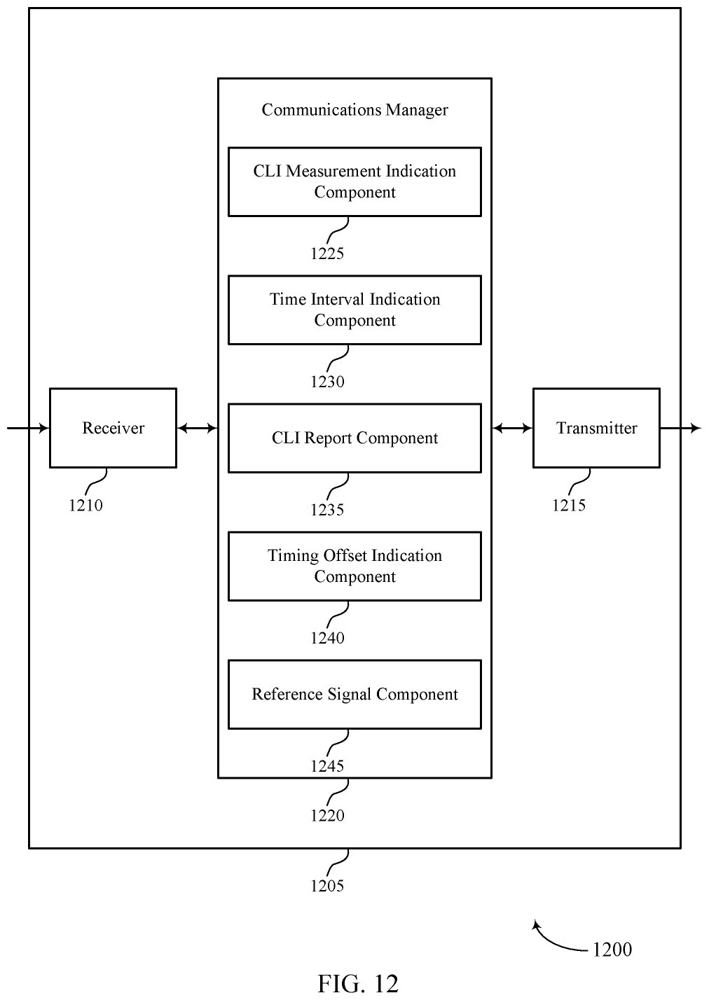

FIG. 12 illustrates a block diagram 1200 of a device 1205 that supports techniques for inter-device CLI measurements in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for inter-device CLI measurements as described herein. For example, the communications manager 1220 may include a CLI measurement indication component 1225, a time interval indication component 1230, a CLI report component 1235, a timing offset indication component 1240, a reference signal component 1245, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity (e.g., the device 1205) in accordance with examples as disclosed herein. The CLI measurement indication component 1225 may be configured as or otherwise support a means for outputting a first indication that triggers reception of one or more UE-to-UE CLI reference signals for one or more UE-to-UE CLI measurements at a UE. The time interval indication component 1230 may be configured as or otherwise support a means for outputting a second indication of a time interval that occurs after the first indication is output from the network entity and that is based on a rule to align a reception timing of the first UE with a transmission timing of a second UE that is associated with transmission of the one or more UE-to-UE CLI reference signals from the second UE. The CLI report component 1235 may be configured as or otherwise support a means for obtaining a report in response to the first indication, where the report indicates one or more CLI metrics corresponding to the one or more UE-to-UE CLI measurements.

Additionally, or alternatively, the communications manager 1220 may support wireless communication at a network entity (e.g., the device 1205) in accordance with examples as disclosed herein. The CLI measurement indication component 1225 may be configured as or otherwise support a means for outputting a first indication that triggers a transmission of one or more UE-to-UE CLI reference signals at a first UE. The timing offset indication component 1240 may be configured as or otherwise support a means for outputting a second indication of a timing offset associated with a transmission timing of the first UE for the transmission of the one or more UE-to-UE CLI reference signals, the timing offset is based on a rule that aligns the transmission timing of the first UE with a reception timing of a second UE that is associated with one or more UE-to-UE CLI measurements at the second UE. The reference signal component 1245 may be configured as or otherwise support a means for obtaining the one or more UE-to-UE CLI reference signals in accordance with the rule and an adjustment to the transmission timing of the first UE that is based on the timing offset.

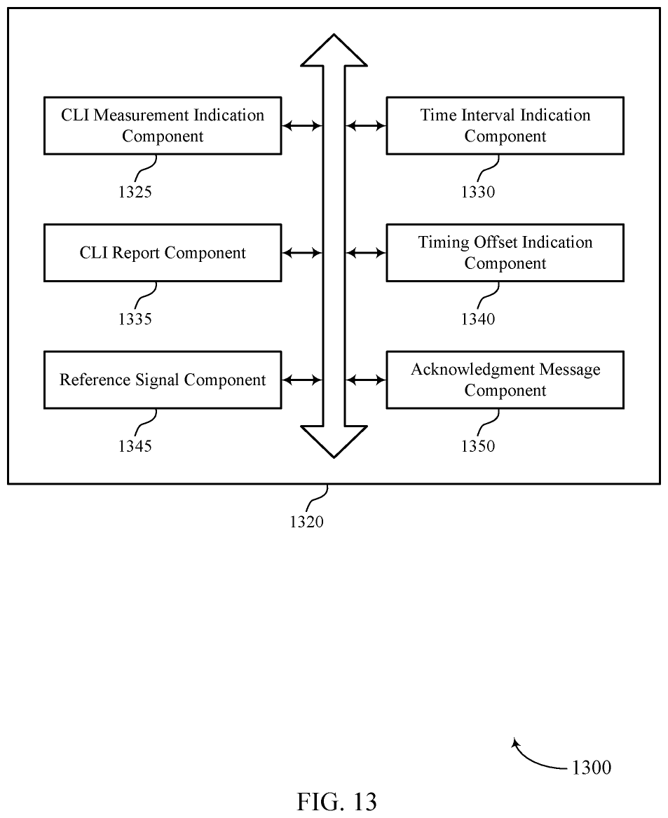

FIG. 13 illustrates a block diagram 1300 of a communications manager 1320 that supports techniques for inter-device CLI measurements in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for inter-device CLI measurements as described herein. For example, the communications manager 1320 may include a CLI measurement indication component 1325, a time interval indication component 1330, a CLI report component 1335, a timing offset indication component 1340, a reference signal component 1345, an acknowledgment message component 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The CLI measurement indication component 1325 may be configured as or otherwise support a means for outputting a first indication that triggers reception of one or more UE-to-UE CLI reference signals for one or more UE-to-UE CLI measurements at a UE. The time interval indication component 1330 may be configured as or otherwise support a means for outputting a second indication of a time interval that occurs after the first indication is output from the network entity and that is based on a rule to align a reception timing of the first UE with a transmission timing of a second UE that is associated with transmission of the one or more UE-to-UE CLI reference signals from the second UE. The CLI report component 1335 may be configured as or otherwise support a means for obtaining a report in response to the first indication, where the report indicates one or more CLI metrics corresponding to the one or more UE-to-UE CLI measurements.

In some examples, to support outputting the first indication, the CLI measurement indication component 1325 may be configured as or otherwise support a means for outputting a control message that includes the first indication via a first time-domain resource, where the control message indicates a second time-domain resource for the one or more UE-to-UE CLI measurements that occurs after the time interval in accordance with the rule.

In some examples, the rule indicates that the first time-domain resource occurs in a first slot and the second time-domain resource occurs in a second slot different from the first slot.

In some examples, the rule indicates that a difference between the first time-domain resource and the second time-domain resource satisfies a threshold that is based on the time interval.

In some examples, the CLI measurement indication component 1325 may be configured as or otherwise support a means for outputting a control message that includes the first indication and the second indication in accordance with the rule.

In some examples, the acknowledgment message component 1350 may be configured as or otherwise support a means for obtaining an acknowledgment message responsive to the first indication, where the time interval occurs after the acknowledgment message is obtained.

In some examples, the time interval is based on one or more capabilities associated with the first UE. In some examples, the reception timing is adjusted in accordance with a timing offset that is based on the rule. In some examples, the timing offset includes a timing advance offset of the first UE for uplink transmissions. In some examples, the timing offset includes a timing advance offset of the second UE that is associated with the transmission timing.

In some examples, the timing offset indication component 1340 may be configured as or otherwise support a means for outputting an indication of the timing offset for the one or more UE-to-UE CLI measurements in accordance with the rule.

In some examples, a second transmission timing of the first UE for uplink transmissions or a second reception timing of the first UE for downlink receptions is adjusted in accordance with a second time interval that occurs before or after the one or more UE-to-UE CLI measurements in accordance with the rule.

In some examples, the one or more UE-to-UE CLI measurements are associated with a half-duplex operation mode at the first UE. In some examples, the one or more UE-to-UE CLI measurements are associated with a full-duplex operation mode at the network entity. In some examples, the one or more UE-to-UE CLI measurements are associated with a SBFD operation mode at the network entity. In some examples, the one or more UE-to-UE CLI measurements are associated with a half-duplex operation mode at the network entity.

In some examples, the timing offset indication component 1340 may be configured as or otherwise support a means for obtaining an indication of a recommended timing offset for the transmission timing.

Additionally, or alternatively, the communications manager 1320 may support wireless communication at a network entity in accordance with examples as disclosed herein. In some examples, the CLI measurement indication component 1325 may be configured as or otherwise support a means for outputting a first indication that triggers a transmission of one or more UE-to-UE CLI reference signals at a first UE. The timing offset indication component 1340 may be configured as or otherwise support a means for outputting a second indication of a timing offset associated with a transmission timing of the first UE for the transmission of the one or more UE-to-UE CLI reference signals, the timing offset is based on a rule that aligns the transmission timing of the first UE with a reception timing of a second UE that is associated with one or more UE-to-UE CLI measurements at the second UE. The reference signal component 1345 may be configured as or otherwise support a means for obtaining the one or more UE-to-UE CLI reference signals in accordance with the rule and an adjustment to the transmission timing of the first UE that is based on the timing offset.

In some examples, the timing offset indication component 1340 may be configured as or otherwise support a means for obtaining an indication of a recommended timing advance offset from the second UE, where the timing offset associated with the transmission timing of the first UE is based on the recommended timing advance offset.

In some examples, the transmission timing of the first UE is adjusted in accordance with the rule to align the transmission timing of the first UE with a second reception timing of the first UE for downlink receptions.

In some examples, a second reception timing of the first UE for downlink receptions or a second transmission timing of the first UE for uplink transmissions is adjusted in accordance with a second time interval that occurs before or after the transmission of the one or more UE-to-UE CLI reference signals and based on the rule.

In some examples, the transmission of the one or more UE-to-UE CLI reference signals is in accordance with a half-duplex operation mode at the first UE. In some examples, the one or more UE-to-UE CLI measurements are associated with a full-duplex operation mode at the network entity. In some examples, the one or more UE-to-UE CLI measurements are associated with a SBFD operation mode at the network entity. In some examples, the one or more UE-to-UE CLI measurements are associated with a half-duplex operation mode at the network entity.

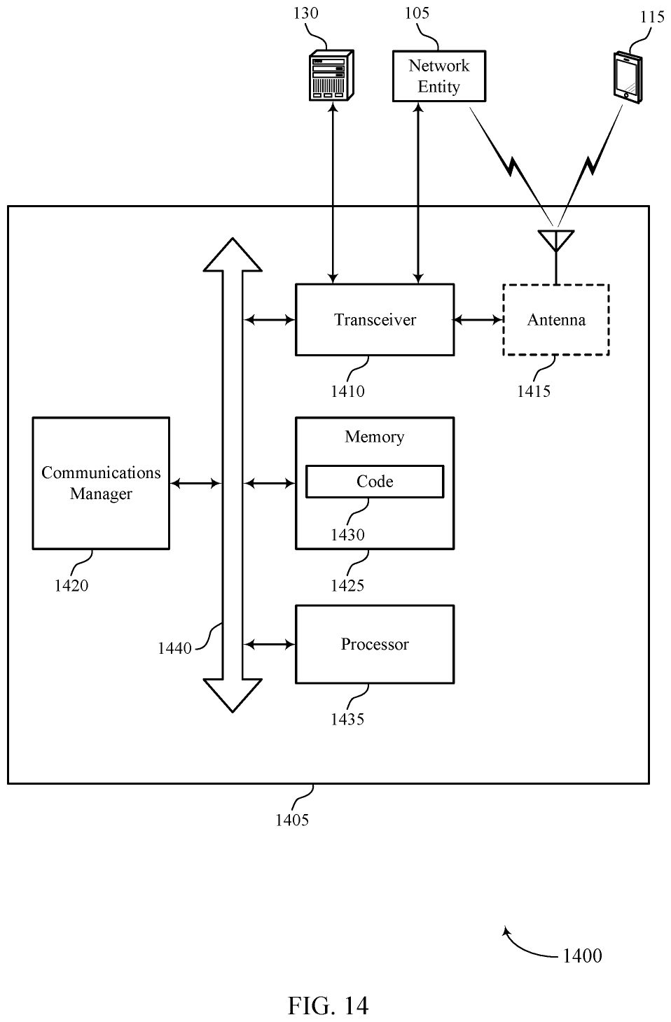

FIG. 14 illustrates a diagram of a system 1400 including a device 1405 that supports techniques for inter-device CLI measurements in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for inter-device CLI measurements). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity (e.g., the device 1405) in accordance with examples as disclosed herein. For example, the communications manager 1420 may be configured as or otherwise support a means for outputting a first indication that triggers reception of one or more UE-to-UE CLI reference signals for one or more UE-to-UE CLI measurements at a UE. The communications manager 1420 may be configured as or otherwise support a means for outputting a second indication of a time interval that occurs after the first indication is output from the network entity and that is based on a rule to align a reception timing of the first UE with a transmission timing of a second UE that is associated with transmission of the one or more UE-to-UE CLI reference signals from the second UE. The communications manager 1420 may be configured as or otherwise support a means for obtaining a report in response to the first indication, where the report indicates one or more CLI metrics corresponding to the one or more UE-to-UE CLI measurements.

Additionally, or alternatively, the communications manager 1420 may support wireless communication at a network entity (e.g., the device 1405) in accordance with examples as disclosed herein. For example, the communications manager 1420 may be configured as or otherwise support a means for outputting a first indication that triggers a transmission of one or more UE-to-UE CLI reference signals at a first UE. The communications manager 1420 may be configured as or otherwise support a means for outputting a second indication of a timing offset associated with a transmission timing of the first UE for the transmission of the one or more UE-to-UE CLI reference signals, the timing offset is based on a rule that aligns the transmission timing of the first UE with a reception timing of a second UE that is associated with one or more UE-to-UE CLI measurements at the second UE. The communications manager 1420 may be configured as or otherwise support a means for obtaining the one or more UE-to-UE CLI reference signals in accordance with the rule and an adjustment to the transmission timing of the first UE that is based on the timing offset.

By including or configuring the communications manager 1420 in accordance with examples as described herein, the device 1405 may support techniques for improved communication reliability, reduced latency, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of techniques for inter-device CLI measurements as described herein, or the processor 1435 and the memory 1425 may be otherwise configured to perform or support such operations.

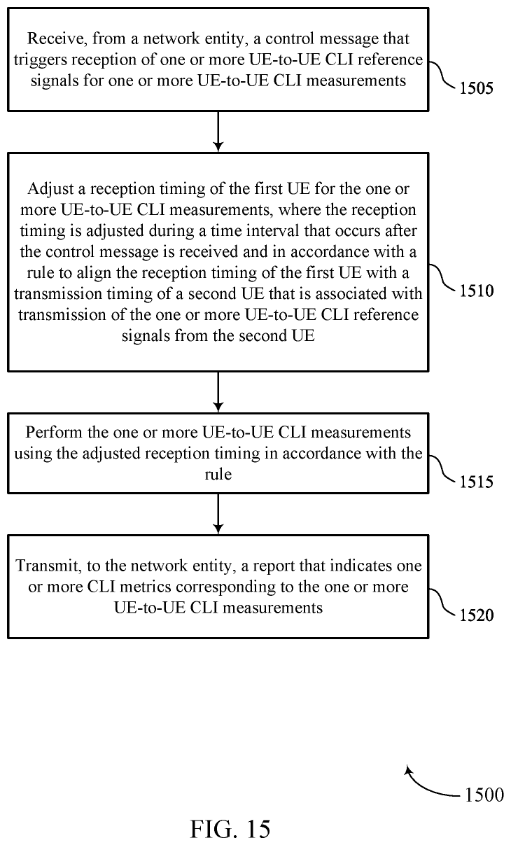

FIG. 15 illustrates a flowchart showing a method 1500 that supports techniques for inter-device CLI measurements in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a control message that triggers reception of one or more UE-to-UE CLI reference signals for one or more UE-to-UE CLI measurements. The operations of 1505 may be performed in accordance with examples as disclosed herein. In some examples, aspects of the operations of 1505 may be performed by a CLI measurement trigger component 925 as described with reference to FIG. 9.

At 1510, the method may include adjusting a reception timing of the first UE for the one or more UE-to-UE CLI measurements, where the reception timing is adjusted during a time interval that occurs after the control message is received and in accordance with a rule to align the reception timing of the first UE with a transmission timing of a second UE that is associated with transmission of the one or more UE-to-UE CLI reference signals from the second UE. The operations of 1510 may be performed in accordance with examples as disclosed herein. In some examples, aspects of the operations of 1510 may be performed by a reception timing component 930 as described with reference to FIG. 9.

At 1515, the method may include performing the one or more UE-to-UE CLI measurements using the adjusted reception timing in accordance with the rule. The operations of 1515 may be performed in accordance with examples as disclosed herein. In some examples, aspects of the operations of 1515 may be performed by a CLI measurement component 935 as described with reference to FIG. 9.

At 1520, the method may include transmitting, to the network entity, a report that indicates one or more CLI metrics corresponding to the one or more UE-to-UE CLI measurements. The operations of 1520 may be performed in accordance with examples as disclosed herein. In some examples, aspects of the operations of 1520 may be performed by a report component 940 as described with reference to FIG. 9.

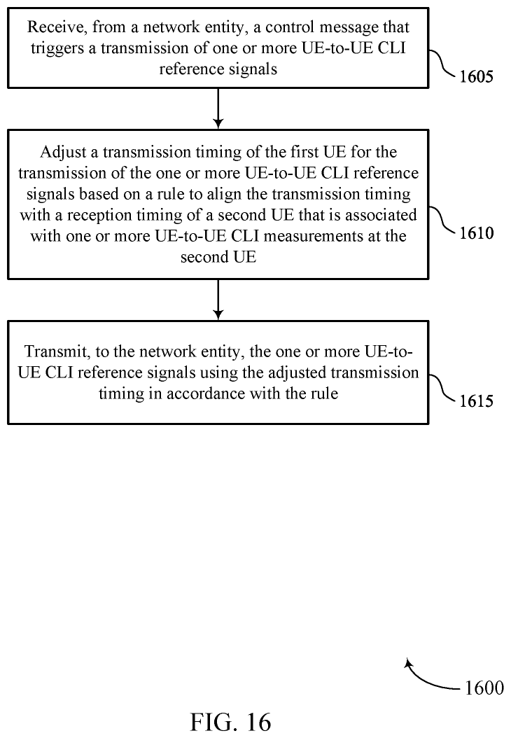

FIG. 16 illustrates a flowchart showing a method 1600 that supports techniques for inter-device CLI measurements in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, a control message that triggers a transmission of one or more UE-to-UE CLI reference signals. The operations of 1605 may be performed in accordance with examples as disclosed herein. In some examples, aspects of the operations of 1605 may be performed by a CLI measurement trigger component 925 as described with reference to FIG. 9.

At 1610, the method may include adjusting a transmission timing of the first UE for the transmission of the one or more UE-to-UE CLI reference signals based on a rule to align the transmission timing with a reception timing of a second UE that is associated with one or more UE-to-UE CLI measurements at the second UE. The operations of 1610 may be performed in accordance with examples as disclosed herein. In some examples, aspects of the operations of 1610 may be performed by a transmission timing component 945 as described with reference to FIG. 9.

At 1615, the method may include transmitting, to the network entity, the one or more UE-to-UE CLI reference signals using the adjusted transmission timing in accordance with the rule. The operations of 1615 may be performed in accordance with examples as disclosed herein. In some examples, aspects of the operations of 1615 may be performed by a CLI reference signal component 950 as described with reference to FIG. 9.

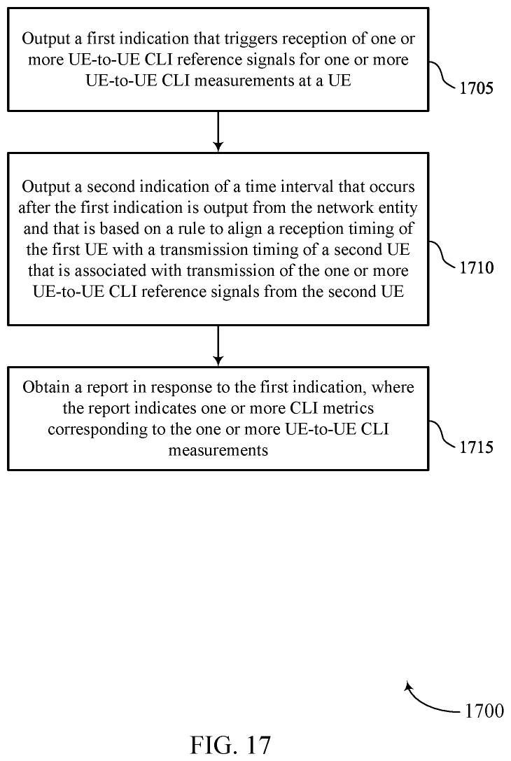

FIG. 17 illustrates a flowchart showing a method 1700 that supports techniques for inter-device CLI measurements in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting a first indication that triggers reception of one or more UE-to-UE CLI reference signals for one or more UE-to-UE CLI measurements at a UE. The operations of 1705 may be performed in accordance with examples as disclosed herein. In some examples, aspects of the operations of 1705 may be performed by a CLI measurement indication component 1325 as described with reference to FIG. 13.

At 1710, the method may include outputting a second indication of a time interval that occurs after the first indication is output from the network entity and that is based on a rule to align a reception timing of the first UE with a transmission timing of a second UE that is associated with transmission of the one or more UE-to-UE CLI reference signals from the second UE. The operations of 1710 may be performed in accordance with examples as disclosed herein. In some examples, aspects of the operations of 1710 may be performed by a time interval indication component 1330 as described with reference to FIG. 13.

At 1715, the method may include obtaining a report in response to the first indication, where the report indicates one or more CLI metrics corresponding to the one or more UE-to-UE CLI measurements. The operations of 1715 may be performed in accordance with examples as disclosed herein. In some examples, aspects of the operations of 1715 may be performed by a CLI report component 1335 as described with reference to FIG. 13.

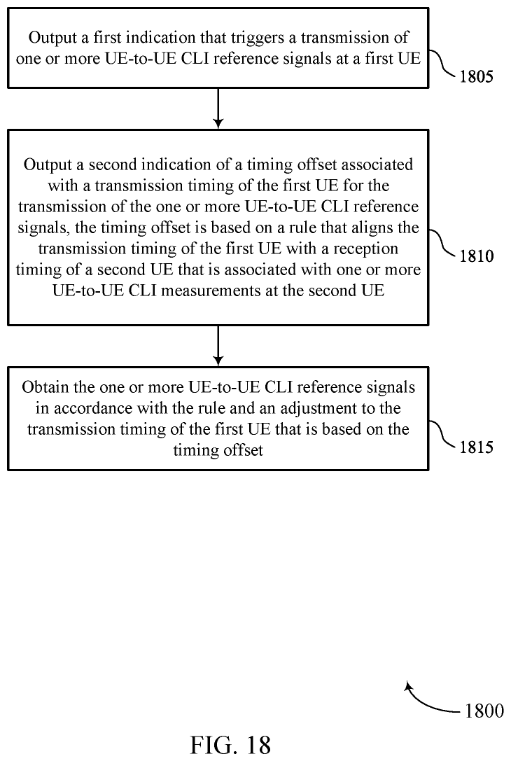

FIG. 18 illustrates a flowchart showing a method 1800 that supports techniques for inter-device CLI measurements in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting a first indication that triggers a transmission of one or more UE-to-UE CLI reference signals at a first UE. The operations of 1805 may be performed in accordance with examples as disclosed herein. In some examples, aspects of the operations of 1805 may be performed by a CLI measurement indication component 1325 as described with reference to FIG. 13.

At 1810, the method may include outputting a second indication of a timing offset associated with a transmission timing of the first UE for the transmission of the one or more UE-to-UE CLI reference signals, the timing offset is based on a rule that aligns the transmission timing of the first UE with a reception timing of a second UE that is associated with one or more UE-to-UE CLI measurements at the second UE. The operations of 1810 may be performed in accordance with examples as disclosed herein. In some examples, aspects of the operations of 1810 may be performed by a timing offset indication component 1340 as described with reference to FIG. 13.

At 1815, the method may include obtaining the one or more UE-to-UE CLI reference signals in accordance with the rule and an adjustment to the transmission timing of the first UE that is based on the timing offset. The operations of 1815 may be performed in accordance with examples as disclosed herein. In some examples, aspects of the operations of 1815 may be performed by a reference signal component 1345 as described with reference to FIG. 13.

The following provides an overview of aspects of the present disclosure:

Aspect 1: A method for wireless communication at a first UE, comprising: receiving, from a network entity, a control message that triggers reception of one or more UE-to-UE CLI reference signals for one or more UE-to-UE CLI measurements; adjusting a reception timing of the first UE for the one or more UE-to-UE CLI measurements, wherein the reception timing is adjusted during a time interval that occurs after the control message is received and in accordance with a rule to align the reception timing of the first UE with a transmission timing of a second UE that is associated with transmission of the one or more UE-to-UE CLI reference signals from the second UE; performing the one or more UE-to-UE CLI measurements using the adjusted reception timing in accordance with the rule; and transmitting, to the network entity, a report that indicates one or more CLI metrics corresponding to the one or more UE-to-UE CLI measurements.

Aspect 2: The method of aspect 1, wherein receiving the control message comprises: receiving the control message via a first time-domain resource, wherein the control message indicates a second time-domain resource for the one or more UE-to-UE CLI measurements that occurs after the time interval in accordance with the rule.

Aspect 3: The method of aspect 2, wherein the rule indicates that the first time-domain resource occurs in a first slot and the second time-domain resource occurs in a second slot different from the first slot.

Aspect 4: The method of aspect 2, wherein the rule indicates that a difference between the first time-domain resource and the second time-domain resource satisfies a threshold that is based at least in part on the time interval.

Aspect 5: The method of any of aspects 1 through 4, further comprising: receiving, from the network entity, an indication of the time interval in accordance with the rule.

Aspect 6: The method of aspect 5, wherein the control message comprises the indication of the time interval.

Aspect 7: The method of any of aspects 1 through 6, further comprising: transmitting, to the network entity, an acknowledgment message responsive to the control message, wherein the time interval is based at least in part on the acknowledgment message.

Aspect 8: The method of any of aspects 1 through 7, wherein the time interval is based at least in part on one or more capabilities of the first UE.

Aspect 9: The method of any of aspects 1 through 8, wherein adjusting the reception timing of the first UE comprises: adjusting the reception timing by applying a timing offset that is based at least in part on the rule.

Aspect 10: The method of aspect 9, wherein the timing offset comprises a timing advance offset of the first UE for uplink transmissions.

Aspect 11: The method of aspect 9, wherein the timing offset comprises a timing advance offset of a second UE that is associated with the transmission timing.

Aspect 12: The method of any of aspects 9 through 11, further comprising: receiving, from the network entity, an indication of the timing offset in accordance with the rule.

Aspect 13: The method of any of aspects 1 through 12, further comprising: adjusting a second transmission timing of the first UE for uplink transmissions or a second reception timing of the first UE for downlink receptions in accordance with a second time interval that occurs before or after the one or more UE-to-UE CLI measurements in accordance with the rule.

Aspect 14: The method of any of aspects 1 through 13, wherein the one or more UE-to-UE CLI measurements are associated with a half-duplex operation mode at the first UE.

Aspect 15: The method of any of aspects 1 through 14, wherein the one or more UE-to-UE CLI measurements are associated with a full-duplex operation mode at the network entity.

Aspect 16: The method of any of aspects 1 through 14, wherein the one or more UE-to-UE CLI measurements are associated with a SBFD operation mode at the network entity.

Aspect 17: The method of any of aspects 1 through 14, wherein the one or more UE-to-UE CLI measurements are associated with a half-duplex operation mode at the network entity and with a misaligned slot format.

Aspect 18: The method of any of aspects 1 through 17, further comprising: transmitting, to the network entity, an indication of a recommended timing offset for adjustment of the transmission timing of the second UE.

Aspect 19: A method for wireless communication at a first UE, comprising: receiving, from a network entity, a control message that triggers a transmission of one or more UE-to-UE CLI reference signals; adjusting a transmission timing of the first UE for the transmission of the one or more UE-to-UE CLI reference signals based at least in part on a rule to align the transmission timing with a reception timing of a second UE that is associated with one or more UE-to-UE CLI measurements at the second UE; and transmitting, to the network entity, the one or more UE-to-UE CLI reference signals using the adjusted transmission timing in accordance with the rule.

Aspect 20: The method of aspect 19, further comprising: receiving, from the network entity, an indication of a timing advance offset associated with the transmission of the one or more UE-to-UE CLI reference signals, wherein the timing advance offset is based at least in part on the rule, and wherein the transmission timing is adjusted in accordance with the timing advance offset.

Aspect 21: The method of any of aspects 19 through 20, wherein adjusting the transmission timing of the first UE comprises: adjusting the transmission timing of the first UE in accordance with the rule to align the transmission timing of the first UE with a second reception timing of the first UE for downlink receptions.

Aspect 22: The method of any of aspects 19 through 21, further comprising: adjusting a second reception timing of the first UE for downlink receptions or a second transmission timing of the first UE for uplink transmissions in accordance with a second time interval that occurs before or after the transmission of the one or more UE-to-UE CLI reference signals and based at least in part on the rule.

Aspect 23: The method of any of aspects 19 through 22, wherein the transmission of the one or more UE-to-UE CLI reference signals is in accordance with a half-duplex operation mode at the first UE.

Aspect 24: The method of any of aspects 19 through 23, wherein the one or more UE-to-UE CLI measurements are associated with a full-duplex operation mode at the network entity.

Aspect 25: The method of any of aspects 19 through 23, wherein the one or more UE-to-UE CLI measurements are associated with a SBFD operation mode at the network entity.

Aspect 26: The method of any of aspects 19 through 23, wherein the one or more UE-to-UE CLI measurements are associated with a half-duplex operation mode at the network entity.

Aspect 27: A method for wireless communication at a network entity, comprising: outputting a first indication that triggers reception of one or more UE-to-UE CLI reference signals for one or more UE-to-UE CLI measurements at a UE; outputting a second indication of a time interval that occurs after the first indication is output from the network entity and that is based at least in part on a rule to align a reception timing of the first UE with a transmission timing of a second UE that is associated with transmission of the one or more UE-to-UE CLI reference signals from the second UE; and obtaining a report in response to the first indication, wherein the report indicates one or more CLI metrics corresponding to the one or more UE-to-UE CLI measurements.

Aspect 28: The method of aspect 27, wherein outputting the first indication comprises: outputting a control message that comprises the first indication via a first time-domain resource, wherein the control message indicates a second time-domain resource for the one or more UE-to-UE CLI measurements that occurs after the time interval in accordance with the rule.

Aspect 29: The method of aspect 28, wherein the rule indicates that the first time-domain resource occurs in a first slot and the second time-domain resource occurs in a second slot different from the first slot.

Aspect 30: The method of aspect 28, wherein the rule indicates that a difference between the first time-domain resource and the second time-domain resource satisfies a threshold that is based at least in part on the time interval.

Aspect 31: The method of any of aspects 27 through 30, further comprising: outputting a control message that comprises the first indication and the second indication in accordance with the rule.

Aspect 32: The method of any of aspects 27 through 31, further comprising: obtaining an acknowledgment message responsive to the first indication, wherein the time interval occurs after the acknowledgment message is obtained.

Aspect 33: The method of any of aspects 27 through 32, wherein the time interval is based at least in part on one or more capabilities associated with the first UE.

Aspect 34: The method of any of aspects 27 through 33, wherein the reception timing is adjusted in accordance with a timing offset that is based at least in part on the rule.

Aspect 35: The method of aspect 34, wherein the timing offset comprises a timing advance offset of the first UE for uplink transmissions.

Aspect 36: The method of aspect 34, wherein the timing offset comprises a timing advance offset of the second UE that is associated with the transmission timing.

Aspect 37: The method of any of aspects 34 through 36, further comprising: outputting an indication of the timing offset for the one or more UE-to-UE CLI measurements in accordance with the rule.

Aspect 38: The method of any of aspects 27 through 37, wherein a second transmission timing of the first UE for uplink transmissions or a second reception timing of the first UE for downlink receptions is adjusted in accordance with a second time interval that occurs before or after the one or more UE-to-UE CLI measurements in accordance with the rule.

Aspect 39: The method of any of aspects 27 through 38, wherein the one or more UE-to-UE CLI measurements are associated with a half-duplex operation mode at the first UE.

Aspect 40: The method of any of aspects 27 through 39, wherein the one or more UE-to-UE CLI measurements are associated with a full-duplex operation mode at the network entity.

Aspect 41: The method of any of aspects 27 through 39, wherein the one or more UE-to-UE CLI measurements are associated with a SBFD operation mode at the network entity.

Aspect 42: The method of any of aspects 27 through 39, wherein the one or more UE-to-UE CLI measurements are associated with a half-duplex operation mode at the network entity.

Aspect 43: The method of any of aspects 27 through 42, further comprising: obtaining an indication of a recommended timing offset for the transmission timing.

Aspect 44: A method for wireless communication at a network entity, comprising: outputting a first indication that triggers a transmission of one or more UE-to-UE CLI reference signals at a first UE; outputting a second indication of a timing offset associated with a transmission timing of the first UE for the transmission of the one or more UE-to-UE CLI reference signals, the timing offset is based at least in part on a rule that aligns the transmission timing of the first UE with a reception timing of a second UE that is associated with one or more UE-to-UE CLI measurements at the second UE; and obtaining the one or more UE-to-UE CLI reference signals in accordance with the rule and an adjustment to the transmission timing of the first UE that is based at least in part on the timing offset.

Aspect 45: The method of aspect 44, further comprising: obtaining an indication of a recommended timing advance offset from the second UE, wherein the timing offset associated with the transmission timing of the first UE is based at least in part on the recommended timing advance offset.

Aspect 46: The method of any of aspects 44 through 45, wherein the transmission timing of the first UE is adjusted in accordance with the rule to align the transmission timing of the first UE with a second reception timing of the first UE for downlink receptions.

Aspect 47: The method of any of aspects 44 through 46, wherein a second reception timing of the first UE for downlink receptions or a second transmission timing of the first UE for uplink transmissions is adjusted in accordance with a second time interval that occurs before or after the transmission of the one or more UE-to-UE CLI reference signals and based at least in part on the rule.

Aspect 48: The method of any of aspects 44 through 47, wherein the transmission of the one or more UE-to-UE CLI reference signals is in accordance with a half-duplex operation mode at the first UE.

Aspect 49: The method of any of aspects 44 through 48, wherein the one or more UE-to-UE CLI measurements are associated with a full-duplex operation mode at the network entity.

Aspect 50: The method of any of aspects 44 through 48, wherein the one or more UE-to-UE CLI measurements are associated with a SBFD operation mode at the network entity.

Aspect 51: The method of any of aspects 44 through 48, wherein the one or more UE-to-UE CLI measurements are associated with a half-duplex operation mode at the network entity.

Aspect 52: An apparatus for wireless communication at a first UE, comprising a processor; memory coupled with the processor; and instructions stored in the memory and executable by the processor to cause the apparatus to perform a method of any of aspects 1 through 18.

Aspect 53: An apparatus for wireless communication at a first UE, comprising at least one means for performing a method of any of aspects 1 through 18.

Aspect 54: A non-transitory computer-readable medium storing code for wireless communication at a first UE, the code comprising instructions executable by a processor to perform a method of any of aspects 1 through 18.

Aspect 55: An apparatus for wireless communication at a first UE, comprising a processor; memory coupled with the processor; and instructions stored in the memory and executable by the processor to cause the apparatus to perform a method of any of aspects 19 through 26.

Aspect 56: An apparatus for wireless communication at a first UE, comprising at least one means for performing a method of any of aspects 19 through 26.

Aspect 57: A non-transitory computer-readable medium storing code for wireless communication at a first UE, the code comprising instructions executable by a processor to perform a method of any of aspects 19 through 26.

Aspect 58: An apparatus for wireless communication at a network entity, comprising a processor; memory coupled with the processor; and instructions stored in the memory and executable by the processor to cause the apparatus to perform a method of any of aspects 27 through 43.

Aspect 59: An apparatus for wireless communication at a network entity, comprising at least one means for performing a method of any of aspects 27 through 43.

Aspect 60: A non-transitory computer-readable medium storing code for wireless communication at a network entity, the code comprising instructions executable by a processor to perform a method of any of aspects 27 through 43.

Aspect 61: An apparatus for wireless communication at a network entity, comprising a processor; memory coupled with the processor; and instructions stored in the memory and executable by the processor to cause the apparatus to perform a method of any of aspects 44 through 51.

Aspect 62: An apparatus for wireless communication at a network entity, comprising at least one means for performing a method of any of aspects 44 through 51.

Aspect 63: A non-transitory computer-readable medium storing code for wireless communication at a network entity, the code comprising instructions executable by a processor to perform a method of any of aspects 44 through 51.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
receive, from a network entity, a control message that triggers reception of one or more UE-to-UE cross-link interference reference signals for one or more UE-to-UE cross-link interference measurements;
adjust a reception timing of the first UE for the one or more UE-to-UE cross-link interference measurements, wherein the reception timing is adjusted during a time interval that occurs after the control message is received and in accordance with a rule to align the reception timing of the first UE with a transmission timing of a second UE that is associated with transmission of the one or more UE-to-UE cross-link interference reference signals from the second UE;
perform the one or more UE-to-UE cross-link interference measurements using the adjusted reception timing in accordance with the rule; and
transmit, to the network entity, a report that indicates one or more cross-link interference metrics corresponding to the one or more UE-to-UE cross-link interference measurements.

2. The apparatus of claim 1, wherein the instructions to receive the control message are executable by the processor to cause the apparatus to:
receive the control message via a first time-domain resource, wherein the control message indicates a second time-domain resource for the one or more UE-to-UE cross-link interference measurements that occurs after the time interval in accordance with the rule.

3. The apparatus of claim 2, wherein the rule indicates that the first time-domain resource occurs in a first slot and the second time-domain resource occurs in a second slot different from the first slot.

4. The apparatus of claim 2, wherein the rule indicates that a difference between the first time-domain resource and the second time-domain resource satisfies a threshold that is based at least in part on the time interval.

5. The apparatus of claim 1, wherein the instructions are further executable by the processor to cause the apparatus to:
receive, from the network entity, an indication of the time interval in accordance with the rule.

6. The apparatus of claim 5, wherein the control message comprises the indication of the time interval.

7. The apparatus of claim 1, wherein the instructions are further executable by the processor to cause the apparatus to:
transmit, to the network entity, an acknowledgment message responsive to the control message, wherein the time interval is based at least in part on the acknowledgment message.

8. The apparatus of claim 1, wherein the time interval is based at least in part on one or more capabilities of the first UE.

9. The apparatus of claim 1, wherein the instructions to adjust the reception timing of the first UE are executable by the processor to cause the apparatus to:
adjust the reception timing by applying a timing offset that is based at least in part on the rule.

10. The apparatus of claim 9, wherein the timing offset comprises a timing advance offset of the first UE for uplink transmissions.

11. The apparatus of claim 9, wherein the timing offset comprises a timing advance offset of a second UE that is associated with the transmission timing.

12. The apparatus of claim 9, wherein the instructions are further executable by the processor to cause the apparatus to:
receive, from the network entity, an indication of the timing offset in accordance with the rule.

13. The apparatus of claim 1, wherein the instructions are further executable by the processor to cause the apparatus to:
adjust a second transmission timing of the first UE for uplink transmissions or a second reception timing of the first UE for downlink receptions in accordance with a second time interval that occurs before or after the one or more UE-to-UE cross-link interference measurements in accordance with the rule.

14. The apparatus of claim 1, wherein the one or more UE-to-UE cross-link interference measurements are associated with a half-duplex operation mode at the first UE.

15. An apparatus for wireless communication at a first user equipment (UE), comprising:
a processor;
memory coupled with the processor; and
instructions stored in the memory and executable by the processor to cause the apparatus to:
receive, from a network entity, a control message that triggers a transmission of one or more UE-to-UE cross-link interference reference signals;
adjust a transmission timing of the first UE for the transmission of the one or more UE-to-UE cross-link interference reference signals based at least in part on a rule to align the transmission timing with a reception timing of a second UE that is associated with one or more UE-to-UE cross-link interference measurements at the second UE; and
transmit, to the network entity, the one or more UE-to-UE cross-link interference reference signals using the adjusted transmission timing in accordance with the rule.

16. The apparatus of claim 15, wherein the instructions are further executable by the processor to cause the apparatus to:
receive, from the network entity, an indication of a timing advance offset associated with the transmission of the one or more UE-to-UE cross-link interference reference signals, wherein the timing advance offset is based at least in part on the rule, and wherein the transmission timing is adjusted in accordance with the timing advance offset.

17. The apparatus of claim 15, wherein the instructions to adjust the transmission timing of the first UE are executable by the processor to cause the apparatus to:
adjust the transmission timing of the first UE in accordance with the rule to align the transmission timing of the first UE with a second reception timing of the first UE for downlink receptions.

18. The apparatus of claim 15, wherein the instructions are further executable by the processor to cause the apparatus to:
adjust a second reception timing of the first UE for downlink receptions or a second transmission timing of the first UE for uplink transmissions in accordance with a second time interval that occurs before or after the transmission of the one or more UE-to-UE cross-link interference reference signals and based at least in part on the rule.

19. The apparatus of claim 15, wherein the transmission of the one or more UE-to-UE cross-link interference reference signals is in accordance with a half-duplex operation mode at the first UE.

20. An apparatus for wireless communication at a network entity, comprising:
a processor;
memory coupled with the processor; and
instructions stored in the memory and executable by the processor to cause the apparatus to:
output a first indication that triggers reception of one or more UE-to-UE cross-link interference reference signals for one or more UE-to-UE cross-link interference measurements at a user equipment (UE);
output a second indication of a time interval that occurs after the first indication is output from the network entity and that is based at least in part on a rule to align a reception timing of the first UE with a transmission timing of a second UE that is associated with transmission of the one or more UE-to-UE cross-link interference reference signals from the second UE; and
obtain a report in response to the first indication, wherein the report indicates one or more cross-link interference metrics corresponding to the one or more UE-to-UE cross-link interference measurements.

21. The apparatus of claim 20, wherein the instructions to output the first indication are executable by the processor to cause the apparatus to:
output a control message that comprises the first indication via a first time-domain resource, wherein the control message indicates a second time-domain resource for the one or more UE-to-UE cross-link interference measurements that occurs after the time interval in accordance with the rule.

22. The apparatus of claim 21, wherein the rule indicates that the first time-domain resource occurs in a first slot and the second time-domain resource occurs in a second slot different from the first slot.

23. The apparatus of claim 21, wherein the rule indicates that a difference between the first time-domain resource and the second time-domain resource satisfies a threshold that is based at least in part on the time interval.

24. The apparatus of claim 20, wherein the instructions are further executable by the processor to cause the apparatus to:
output a control message that comprises the first indication and the second indication in accordance with the rule.

25. The apparatus of claim 20, wherein the instructions are further executable by the processor to cause the apparatus to:
obtain an acknowledgment message responsive to the first indication, wherein the time interval occurs after the acknowledgment message is obtained.

26. The apparatus of claim 20, wherein the one or more UE-to-UE cross-link interference measurements are associated with a full-duplex operation mode at the network entity.

27. The apparatus of claim 20, wherein the one or more UE-to-UE cross-link interference measurements are associated with a subband full-duplex operation mode at the network entity.

28. The apparatus of claim 20, wherein the one or more UE-to-UE cross-link interference measurements are associated with a half-duplex operation mode at the network entity.

29. An apparatus for wireless communication at a network entity, comprising:
a processor;
memory coupled with the processor; and
instructions stored in the memory and executable by the processor to cause the apparatus to:
output a first indication that triggers a transmission of one or more UE-to-UE cross-link interference reference signals at a first user equipment (UE);
output a second indication of a timing offset associated with a transmission timing of the first UE for the transmission of the one or more UE-to-UE cross-link interference reference signals, the timing offset is based at least in part on a rule that aligns the transmission timing of the first UE with a reception timing of a second UE that is associated with one or more UE-to-UE cross-link interference measurements at the second UE; and
obtain the one or more UE-to-UE cross-link interference reference signals in accordance with the rule and an adjustment to the transmission timing of the first UE that is based at least in part on the timing offset.

30. The apparatus of claim 29, wherein the instructions are further executable by the processor to cause the apparatus to:
obtain an indication of a recommended timing advance offset from the second UE, wherein the timing offset associated with the transmission timing of the first UE is based at least in part on the recommended timing advance offset.
